(19) United States
(12) Patent Application Publication
(10) Pub. No.: US 2013/0076924 A1
(43) Pub. Date: Mar. 28, 2013

(54) Shake Correction Device, Photographic Optical Device and Lens Drive Device

(71) Applicants: Tatsuki Wade, Nagano (JP); Shinroku Asakawa, Nagano (JP); Shinji Minamisawa, Nagano (JP)

(72) Inventors: Tatsuki Wade, Nagano (JP); Shinroku Asakawa, Nagano (JP); Shinji Minamisawa, Nagano (JP)

(73) Assignee: NIDEC SANKYO CORPORATION, Nagano (JP)

(21) Appl. No.: 13/702,460

(22) PCT Filed: May 24, 2011
(86) PCT No.: PCT/JP2011/061820

§ 371 Date: Dec. 6, 2012

(30) Foreign Application Priority Data
Jun. 8, 2010 (JP) 2010-130599
Jun. 8, 2010 (JP) 2010-130600

(51) Int. Cl. H04N 5/232

(52) U.S. Cl. CPC H04N 5/23287
USPC 348/208.11

(57) ABSTRACT

A shake correction device may include a support body to swingably support a camera module; and a shake correction mechanism to correct the shake by swinging the camera module so as to incline an optical axis of the lens with respect to the support body. The support body may include a case body formed in a substantially tube shape. The shake correction mechanism may include a shake correction coil fixed to an inner peripheral face of the case body; a shake correction magnet disposed on an inner peripheral side of the case body; and a spring member having a support body fixing part which is fixed to the support body, a magnet holding part which holds the shake correction magnet, and a spring part which connects the support body fixing part with the magnet holding part.

### CROSS REFERENCE TO RELATED APPLICATIONS

This is a U.S. national stage of International Application No. PCT/JP2011/061820, filed on May 24, 2011. Priority under 35 U.S.C. §119(a) and 35 U.S.C. §365(b) is claimed from Japanese Application Nos. 2010-130599, filed Jun. 8, 2010, and 2010-130600, filed Jun. 8, 2010, the disclosures of which are also incorporated herein by reference.

### TECHNICAL FIELD

The present invention relates to a shake correction device for correcting a shake for an optical image. Further, the present invention relates to a photographic optical device and a lens drive device which are provided with the shake correction device.

### BACKGROUND

In recent years, a photographic optical device is mounted on a portable device such as a cellular phone. When a portable device is used, a shake in the hand may be easily occurred at a time of photographing. In order to prevent this problem, the present applicant has proposed a photographic optical device which is capable of correcting a shake in the hand at a time of photographing (see, for example, Patent Literature 1).

The photographic optical device described in Patent Literature 1 includes a movable module on which a lens and an imaging element are mounted, a fixed body which supports the movable module, and a shake correction mechanism for swinging the movable module on the fixed body to correct a shake in the hand. The movable module includes a movable body which holds a lens and is movable in an optical axis direction, a support body which supports the movable body so as to be movable in the optical axis direction, and a lens drive coil and a lens drive magnet for moving the movable body in the optical axis direction. The lens drive coil is wound around on an outer peripheral face of the movable body. The support body is provided with a case in a rectangular tube shape which structures an outer peripheral face of the movable module. The lens drive magnet is fixed to an inner peripheral face of the case so as to face the lens drive coil. Further, the outer peripheral face of the movable module (in other words, outer peripheral face of the case) is covered by a yoke in a rectangular tube shape which is separately prepared from the case.

Further, in the photographic optical device described in Patent Literature 1, the shake correction mechanism includes a shake correction coil and a shake correction magnet. The shake correction magnet is fixed to the outer peripheral face of the yoke. Further, a fixed body in a rectangular tube shape which structures an outer peripheral face of the photographic optical device is disposed so as to surround the outer peripheral face of the yoke. The shake correction coil is fixed to an inner peripheral face of the fixed body so as to face the shake correction magnet through a predetermined gap space. In the photographic optical device, the movable module and the fixed body are connected with each other through a gimbal spring. The gimbal spring is provided with an inner peripheral side connecting part in a rectangular frame shape, an outer peripheral side connecting part in a rectangular frame shape, and an arm part which connects the inner peripheral side connecting part with the outer peripheral side connecting part. The inner peripheral side connecting part is fixed to the yoke and the outer peripheral side connecting part is fixed to the fixed body.
[PTL 1] Japanese Patent Laid-Open No. 2009-294393

In order to appropriately swing the movable module to correct a shake in the hand appropriately, a relative positional accuracy between the shake correction coil and the shake correction magnet is required to be enhanced for enhancing accuracy of a gap space between the shake correction coil and the shake correction magnet and the like. Further, in recent years, in the market of a portable device such as a cellular phone, requirement for making a portable device thinner has been further increased and, as a result, requirement for making a photographic optical device which is mounted on the portable device thinner has been also increased.

### SUMMARY

In view of the problem described above, at least an embodiment of the present invention provides a shake correction device which is capable of reducing its size while enhancing relative positional accuracy between the shake correction coil and the shake correction magnet in the shake correction device that is mounted on a lens drive device structured to drive a photographic lens or a photographic optical device. Further, in view of the problem described above, at least an embodiment of the present invention provides a photographic optical device and a lens drive device which includes the shake correction device.

In order to solve the problem, a first embodiment of the present invention provides a shake correction device structured to correct a shake for an optical image including a support body structured to swingably support a camera module having a lens and an imaging element, and a shake correction mechanism structured to correct the shake by swinging the camera module so as to incline an optical axis of the lens with respect to the support body. The support body includes a case body formed in a substantially tube shape. The shake correction mechanism includes a shake correction coil which is fixed to an inner peripheral face of the case body, a shake correction magnet which is disposed on an inner peripheral side of the case body with respect to the shake correction coil so as to face the shake correction coil, and a spring member having a support body fixing part which is fixed to the support body, a magnet holding part which holds the shake correction magnet, and a spring part which connects the support body fixing part with the magnet holding part. An accommodating space which is capable of accommodating the camera module is formed on an inner peripheral side of the case body with respect to the shake correction magnet.

Further, in order to solve the problem, at least an embodiment of the present invention provides a shake correction device structured to correct a shake for an optical image including a support body structured to swingably support a lens drive module having a movable body to which a lens is capable of being attached and which is movable in an optical axis direction of the lens, a holding body which movably holds the movable body in the optical axis direction, and a lens drive mechanism structured to drive the movable body in the optical axis direction, and a shake correction mechanism structured to correct the shake by swinging the lens drive module so as to incline an optical axis of the lens with respect to the support body. The support body includes a case body which is formed in a substantially tube shape. The shake correction mechanism includes a shake correction coil which is fixed to an inner peripheral face of the case body, a shake correction magnet which is disposed on an inner peripheral side of the case body with respect to the shake correction coil so as to face the shake correction coil, and a spring member having a support body fixing part which is fixed to the support body, a magnet holding part which holds the shake correction magnet, and a spring part which connects the support body fixing part with the magnet holding part. An accommodating space which is capable of accommodating the lens drive module is formed on an inner peripheral side of the case body with respect to the shake correction magnet.

According to the shake correction device in at least an embodiment of the present invention, the shake correction coil is fixed to an inner peripheral face of the case body structuring the support body and the support body fixing part of the spring member is fixed to the support body. Further, in at least an embodiment of the present invention, the shake correction magnet is held by the magnet holding part of the spring member. In addition, in at least an embodiment of the present invention, an accommodating space which is capable of disposing a camera module or a lens drive module is formed on an inner peripheral side of the case body with respect to the shake correction magnet. Therefore, in at least an embodiment of the present invention, the shake correction coil and the shake correction magnet can be integrated with each other through the support body, the spring member and the like before a camera module or a lens drive module is incorporated. Accordingly, in at least an embodiment of the present invention, influence of dimensional accuracy and assembling accuracy of the camera module or the lens drive module exerted upon the relative positional accuracy between the shake correction coil and the shake correction magnet is reduced and, as a result, the relative positional accuracy between the shake correction coil and the shake correction magnet is enhanced in comparison with the conventional structure. For example, accuracy of a gap space between the shake correction coil and the shake correction magnet is enhanced.

Further, in at least an embodiment of the present invention, the shake correction coil and the shake correction magnet are integrated with each other through the support body, the spring member and the like before the camera module or the lens drive module is incorporated. Therefore, the shake correction device in a state that the camera module or the lens drive module is not incorporated yet and the shake correction device in a state that the camera module or the lens drive module has been incorporated can be distributed in the market. Accordingly, in at least an embodiment of the present invention, a distributing method of the shake correction device can be diversified.

In at least an embodiment of the present invention, it is preferable that the shake correction mechanism includes a plurality of the shake correction magnets and a magnet holder which holds the plurality of the shake correction magnets, and the magnet holder is fixed to the magnet holding part of the spring member. According to this structure, a plurality of the shake correction magnets is integrated with each other through the magnet holder and thus relative positional accuracy between a plurality of the shake correction magnets is enhanced and, as a result, relative positional accuracy between the shake correction coil and the shake correction magnet is enhanced effectively. Further, since a plurality of the shake correction magnets is integrated with each other through the magnet holder, even in a shake correction device in which a camera module or a lens drive module is not incorporated, the shake correction magnets can be stabilized. Further, since a plurality of the shake correction magnets is integrated with each other through the magnet holder, handling of the shake correction magnets is easy at the time of assembling of the shake correction device in comparison with a case that a plurality of shake correction magnets is handled individually.

In at least an embodiment of the present invention, it is preferable that the magnet holder holds at least both end sides of a plurality of the shake correction magnets in an optical axis direction of the lens. According to this structure, rigidity of the magnet body which is structured of a plurality of the shake correction magnets and the magnet holder is enhanced.

In at least an embodiment of the present invention, it is preferable that a positioning part is formed in the magnet holder for positioning the magnet holding part in a direction which is substantially perpendicular to an optical axis direction of the lens. According to this structure, relative positional accuracy between the magnet holding part and the magnet holder is enhanced and, as a result, relative positional accuracy between the shake correction coil and the shake correction magnet is enhanced effectively.

In at least an embodiment of the present invention, it is preferable that the shake correction mechanism is provided with a supporting point part as a swing center for the camera module. Further, in at least an embodiment of the present invention, it is preferable that the shake correction mechanism is provided with a supporting point part as a swing center for the lens drive module. According to this structure, inspection of the shake correcting function can be performed by incorporating a dummy module for inspection (dummy module) instead of incorporating the camera module or the lens drive module. In this case, a dummy module is temporarily fixed by utilizing an attraction force of the shake correction magnet and thus, even in a state that an axial direction of the dummy module is inclined with respect to the vertical direction, inspection for the shake correcting function can be performed. In other words, the inspection for the shake correcting function can be performed in all postures.

The shake correction device in at least an embodiment of the present invention may be used in a photographic optical device which includes a camera module to which the shake correction magnet is fixed. Further, the shake correction device in at least an embodiment of the present invention may be used in a lens drive device which includes a lens drive module to which the shake correction magnet is fixed. In the photographic optical device or the lens drive device, relative positional accuracy between the shake correction coil and the shake correction magnet is enhanced and thus a correcting function for a shake is enhanced.

In at least an embodiment of the present invention, it is preferable that the shake correction mechanism includes a supporting point part as a swing center for the camera module and, when a side where an object to be photographed is located is an object side and a side where the imaging element is disposed is an opposite-to-object side in an optical axis direction of the lens, the supporting point part is disposed on the opposite-to-object side with respect to the camera module and the support body fixing part is disposed on the opposite-to-object side with respect to the magnet holding part. Further, in at least an embodiment of the present invention, it is preferable that the shake correction mechanism includes a supporting point part as a swing center for the lens drive module and, when a side where an object to be photographed is located is an object side and an opposite side to an object to be photographed side is an opposite-to-object side in the optical axis direction, the supporting point part is disposed on the opposite-to-object side with respect to the lens drive module and the support body fixing part is disposed on the opposite-to-object side with respect to the magnet holding part. According to this structure, the camera module and the lens drive module are urged toward the supporting point part by utilizing the spring member and thus the swing operations of the camera module and the lens drive module are stabilized.

In at least an embodiment of the present invention, it is preferable that the support body includes an opposite-to-object side case body which is formed with an abutting part with which a support-point protruded part structuring the supporting point part is abutted, or where the support-point protruded part is formed or fixed, and a fixing member structured to fix the support body fixing part, and the support body fixing part is fixed in a sandwiched state between the fixing member and the opposite-to-object side case body in the optical axis direction. According to this structure, the support body fixing part is fixed with the opposite-to-object side case body as a reference in the optical axis direction and thus relative positional accuracy between the support body fixing part and the supporting point part in the optical axis direction is easily secured. Therefore, the camera module and the lens drive module are appropriately urged toward the supporting point part by utilizing the spring member and thus the swing operations of the camera module and the lens drive module are further stabilized.

In order to solve the problem, a second embodiment of the present invention provides a photographic optical device including a camera module having a lens and an imaging element, and a shake correction device structured to correct a shake for an optical image which is formed on the imaging element through the lens. The shake correction device includes a support body which swingably supports the camera module, and a shake correction mechanism structured to swing the camera module so as to incline an optical axis of the lens with respect to the support body to correct the shake. The shake correction mechanism includes a shake correction magnet which is directly fixed to an outer peripheral face of the camera module and a shake correction coil which is fixed to the support body and is oppositely disposed to the shake correction magnet.

Further, in order to solve the problem, at least an embodiment of the present invention provides a lens drive device including a lens drive module having a movable body which is capable of attaching a lens and is movable in an optical axis direction of the lens, a holding body which movably holds the movable body in the optical axis direction, and a lens drive mechanism structured to drive the movable body in the optical axis direction, and a shake correction device structured to correct a shake for an optical image which is formed through the lens. The shake correction device includes a support body which swingably supports the lens drive module and a shake correction mechanism structured to swing the lens drive module so as to incline an optical axis of the lens with respect to the support body to correct the shake. The shake correction mechanism includes a shake correction magnet which is directly fixed to an outer peripheral face of the lens drive module and a shake correction coil which is fixed to the support body and is oppositely disposed to the shake correction magnet.

In the photographic optical device according to at least an embodiment of the present invention, the shake correction magnet which structures the shake correction mechanism is directly fixed to an outer peripheral face of the camera module. Further, in the lens drive device according to at least an embodiment of the present invention, the shake correction magnet which structures the shake correction mechanism is directly fixed to an outer peripheral face of the lens drive module. Therefore, according to at least an embodiment of the present invention, the sizes of the photographic optical device and the lens drive device are reduced in comparison with a case that the shake correction magnet is fixed to a yoke which is disposed so as to cover the outer peripheral face of the camera module and the outer peripheral face of the lens drive module. Further, according to at least an embodiment of the present invention, the weight of the swinging portion is reduced in comparison with a case that a yoke is disposed so as to cover the outer peripheral face of the camera module and the outer peripheral face of the lens drive module. According to at least an embodiment of the present invention, in the case that the size of the photographic optical device or the lens drive device is the same as that of a conventional one, the sizes of the shake correction magnet and the shake correction coil can be made larger by the space of the yoke and thus, a drive force of the swing drive mechanism can be enhanced.

In the photographic optical device according to at least an embodiment of the present invention, it is preferable that the camera module includes a movable body which holds the lens and is movable in an optical axis direction of the lens, a holding body which movably holds the movable body in the optical axis direction, and a lens drive mechanism structured to drive the movable body in the optical axis direction. The lens drive mechanism includes a lens drive coil which is fixed to an outer peripheral face of the movable body, and a lens drive magnet which is fixed to the holding body and is oppositely disposed to the lens drive coil. The holding body is provided with a cover member in a substantially tube shape which is formed of magnetic material and structures an outer peripheral face of the camera module, and the lens drive magnet is fixed to an inner peripheral face of the cover member and the shake correction magnet is fixed to an outer peripheral face of the cover member. Further, in the lens drive device according to at least an embodiment of the present invention, it is preferable that the lens drive mechanism includes a lens drive coil which is fixed to an outer peripheral face of the movable body and a lens drive magnet which is fixed to the holding body and is oppositely disposed to the lens drive coil, and the holding body is provided with a cover member in a substantially tube shape which is formed of magnetic material and structures an outer peripheral face of the lens drive module, and the lens drive magnet is fixed to an inner peripheral face of the cover member and the shake correction magnet is fixed to an outer peripheral face of the cover member.

According to this structure, since the cover member functions as a back yoke, magnetic flux density passing through the lens drive coil which is oppositely disposed to the lens drive magnet is enhanced and magnetic flux density passing through the shake correction coil which is oppositely disposed to the shake correction magnet is enhanced. Further, interference between the magnetic flux generated from the lens drive magnet and the magnetic flux generated from the shake correction magnet is restrained. Accordingly, the lens can be appropriately moved in the optical axis direction and the camera module and the lens drive module can be swung appropriately.

In at least an embodiment of the present invention, it is preferable that a first opposing face which is an opposing face of the lens drive magnet that faces the shake correction magnet through the cover member and a second opposing face which is an opposing face of the shake correction magnet that faces the first opposing face through the cover member are magnetized so that two different magnetic poles are superposed on each other in the optical axis direction and, when a side on which an object to be photographed is located is an object side in the optical axis direction, the lens drive magnet and the shake correction magnet are fixed to the cover member so that the magnetic pole disposed on the object side of the first opposing face is different from the magnetic pole disposed on the object side of the second opposing face. According to this structure, an effective magnetic circuit is formed and thus drive forces of the lens drive mechanism and the shake correction mechanism can be enhanced.

In at least an embodiment of the present invention, it is preferable that the shake correction mechanism includes a spring member which connects the camera module and the support body, and the spring member includes a movable side fixing part which is directly fixed to the camera module, a fixed side fixing part which is fixed to the support body, and a spring part which connect the movable side fixing part with the fixed side fixing part and is structured to enable to perform a swing operation of the camera module. Further, in at least an embodiment of the present invention, it is preferable that the shake correction mechanism includes a spring member which connects the lens drive module and the support body, and the spring member includes a movable side fixing part which is directly fixed to the lens drive module, a fixed side fixing part which is fixed to the support body, and a spring part which connect the movable side fixing part with the fixed side fixing part and is structured to enable to perform a swing operation of the lens drive module. According to this structure, the movable side fixing part of the spring member is directly fixed to the camera module or the lens drive module and thus, in comparison with a case that another member to which the movable side fixing part is fixed is provided separately, the sizes of the photographic optical device and the lens drive device are reduced.

In at least an embodiment of the present invention, it is preferable that the shake correction mechanism includes a supporting point part as a swing center for the camera module and, when a side where an object to be photographed is located is an object side and a side where the imaging element is disposed is an opposite-to-object side in an optical axis direction of the lens, the supporting point part is disposed on the opposite-to-object side with respect to the camera module and the fixed side fixing part is disposed on the opposite-to-object side with respect to the movable side fixing part. Further, in at least an embodiment of the present invention, it is preferable that the shake correction mechanism includes a supporting point part as a swing center for the lens drive module and, when a side where an object to be photographed is located is an object side and an opposite side to the object to be photographed is an opposite-to-object side in the optical axis direction, the supporting point part is disposed on the opposite-to-object side with respect to the lens drive module and the fixed side fixing part is disposed on the opposite-to-object side with respect to the movable side fixing part. According to this structure, the camera module and the lens drive module are urged toward the supporting point part by utilizing the spring member and thus swing operations of the camera module and the lens drive module can be stabilized.

In at least an embodiment of the present invention, it is preferable that the camera module is formed with a spring fixing protruded part to which the movable side fixing part is fixed so as to protrude in a direction substantially perpendicular to the optical axis direction and the movable side fixing part is fixed to a face on the object side of the spring fixing protruded part. Further, in at least an embodiment of the present invention, it is preferable that the lens drive module is formed with a spring fixing protruded part to which the movable side fixing part is fixed so as to protrude in a direction substantially perpendicular to the optical axis direction and the movable side fixing part is fixed to a face on the object side of the spring fixing protruded part. When the movable side fixing part is fixed to a face on the opposite-to-object side of the spring fixing protruded part, the movable side fixing part may be easily separated from the face on the opposite-to-object side of the spring fixing protruded part by the urging force of the spring member. However, according to the above-mentioned structure, the movable side fixing part is prevented from being separated from the spring fixing protruded part.

In at least an embodiment of the present invention, it is preferable that the spring fixing protruded part is formed over an entire periphery of the camera module and the movable side fixing part is formed in a ring shape. Further, in at least an embodiment of the present invention, it is preferable that the spring fixing protruded part is formed over an entire periphery of the lens drive module and the movable side fixing part is formed in a ring shape.

According to this structure, the urging force of the spring member is acted over the entire periphery of the camera module or the lens drive module and thus, a swing operation of the camera module or the lens drive module can be further stabilized.

In at least an embodiment of the present invention, it is preferable that the support body includes an opposite-to-object side case body which is formed with an abutting part with which a support-point protruded part structuring the supporting point part is abutted, or where the support-point protruded part is formed or fixed, and a fixing member structured to fix the fixed side fixing part, and the fixed side fixing part is fixed in a sandwiched state between the fixing member and the opposite-to-object side case body in the optical axis direction. According to this structure, the fixed side fixing part can be fixed with the opposite-to-object side case body as a reference in the optical axis direction and thus relative positional accuracy in the optical axis direction between the fixed side fixing part and the supporting point part is easily secured. Therefore, the camera module and the lens drive module are appropriately urged toward the supporting point part by utilizing the spring member and thus the swing operations of the camera module and the lens drive module can be stabilized.

In at least an embodiment of the present invention, it is preferable that the shake correction mechanism includes a plurality of the shake correction magnets and a plurality of the shake correction coils for swinging the camera module with a first direction and a second direction which are substantially perpendicular to the optical axis direction and are substantially perpendicular to each other as axial directions for swinging, and the spring part is provided with a first spring part which is substantially parallel to the first direction and a second spring part which is substantially parallel to the second direction. Further, in at least an embodiment of the present invention, it is preferable that the shake correction mechanism includes a plurality of the shake correction magnets and a plurality of the shake correction coils for swinging the lens drive module with a first direction and a second direction which are substantially perpendicular to the optical axis direction and are substantially perpendicular to each other as axial directions for swinging, and the spring part is provided with a first spring part which is substantially parallel to the first direction and a second spring part which is substantially parallel to the second direction. According to this structure, the spring constant of the spring member in the second direction can be made relatively small by an operation of the first spring part which is substantially parallel to the first direction, and the spring constant of the spring member in the first direction can be made relatively small by an operation of the second spring part which is substantially parallel to the second direction. Therefore, the movable side fixing part can be smoothly moved in the second direction by the first spring part and the movable side fixing part can be smoothly moved in the first direction by the second spring part. As a result, even when swing angles of the camera module and the lens drive module are large, the camera module and the lens drive module can be swung smoothly.

As described above, in the shake correction device according to at least an embodiment of the present invention, relative positional accuracy between the shake correction coil and the shake correction magnet is enhanced. Further, in the photographic optical device and the lens drive device according to at least an embodiment of the present invention, relative positional accuracy between the shake correction coil and the shake correction magnet is enhanced and thus the correcting function for a shake is enhanced. In addition, according to at least an embodiment of the present invention, the sizes of the photographic optical device and the lens drive device can be reduced.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing a photographic optical device in accordance with an embodiment of the present invention.

FIG. 2 is a cross-sectional view showing the “E-E” cross section in FIG. 1.

FIG. 3 is an exploded perspective view showing the photographic optical device in FIG. 1.

FIG. 4 is an exploded perspective view showing a camera module in FIG. 3.

FIG. 5 is a perspective view showing a shake correction device in FIG. 1.

FIG. 6 is a cross-sectional view showing the “F-F” cross section in FIG. 5.

FIG. 7 is a perspective view showing an assembled state of a plate spring, shake correction magnets and a magnet holder shown in FIG. 3, which is viewed from an opposite-to-object side.

FIG. 8 is a process chart showing an assembling procedure for the photographic optical device shown in FIG. 1.

FIG. 9 is a perspective view showing a photographic optical device in accordance with an embodiment of the present invention.

FIG. 10 is a cross-sectional view showing the “E-E” cross section in FIG. 9.

FIG. 11 is an exploded perspective view showing the photographic optical device in FIG. 9.

FIG. 12 is an exploded perspective view showing a camera module in FIG. 11.

FIG. 13 is an explanatory perspective view showing magnetized states of lens drive magnets and shake correction magnets shown in FIG. 10.

FIG. 14 is an explanatory perspective view showing an arrangement relationship of a camera module, a plate spring and a lower case body shown in FIG. 10.

FIG. 15 is a perspective view showing a plate spring in FIG. 11.

### DESCRIPTION OF EMBODIMENTS

A first embodiment of the present invention will be described below with reference to the accompanying drawings.

### (Schematic Structure of Photographic Optical Device)

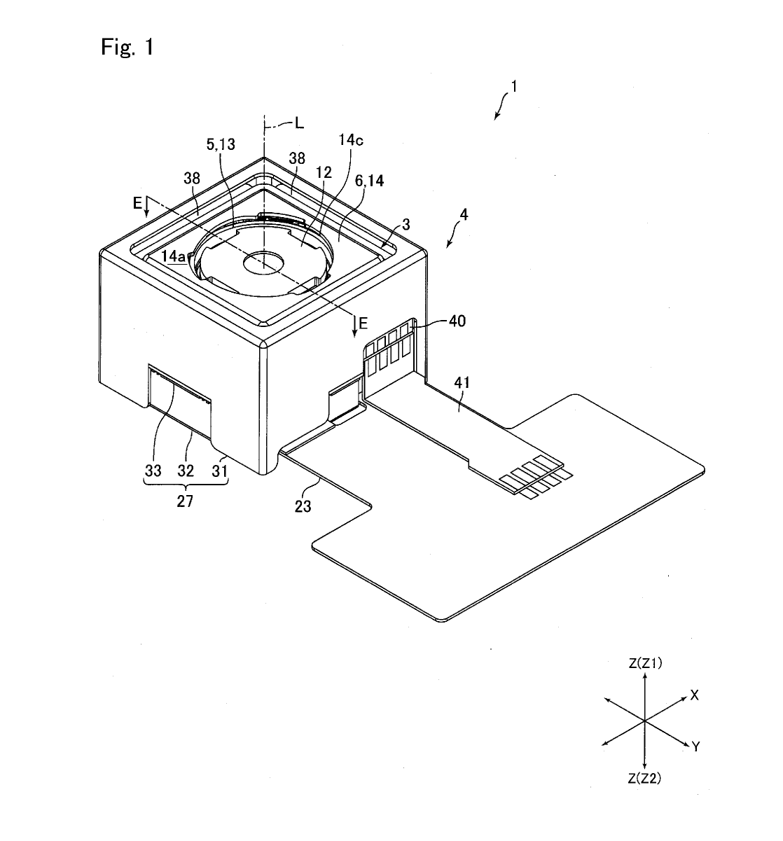

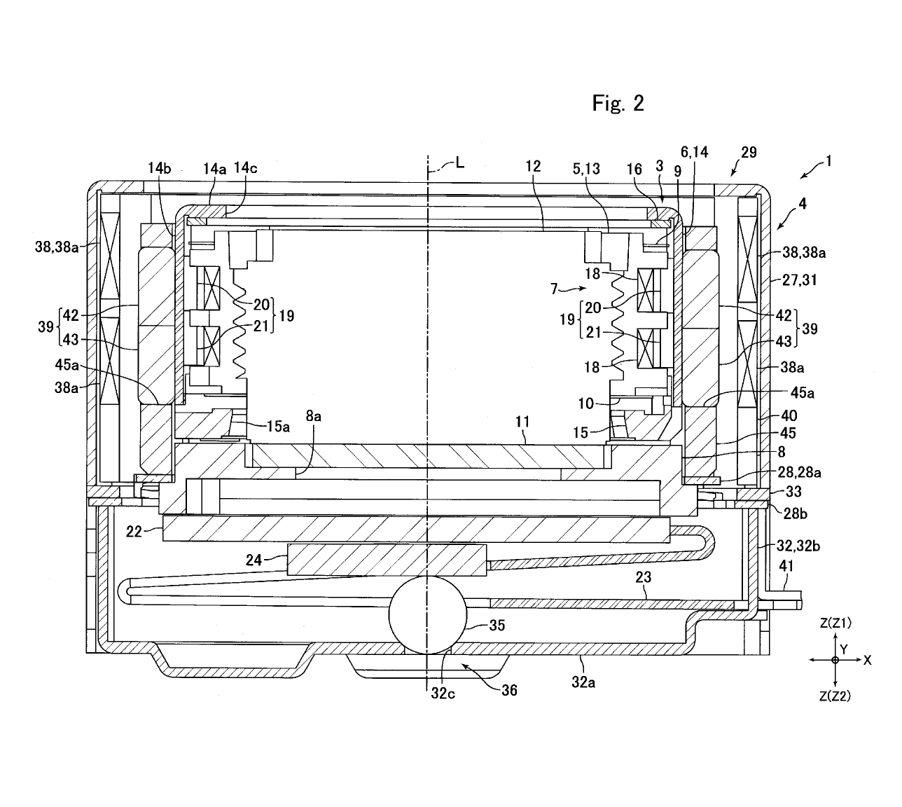

FIG. 1 is a perspective view showing a photographic optical device 1 in accordance with an embodiment of the present invention. FIG. 2 is a cross-sectional view showing the “E-E” cross section in FIG. 1. In the following description, as shown in FIG. 1, three directions perpendicular to each other are set to be an “X” direction, a “Y” direction and a “Z” direction, and the “X” direction is set to be a right and left direction, the “Y” direction is set to be a front and rear direction, and the “Z” direction is set to be an upper and lower direction. Further, a “Z1” direction side is an “upper” side and a “Z2” direction side is a “lower” side.

The photographic optical device 1 in this embodiment is a small and thin type camera which is mounted on a portable device such as a cellular phone, a drive recorder, a monitoring camera system or the like and is provided with an autofocus function and a shake correcting function. The photographic optical device 1 is generally formed in a substantially rectangular prism shape. In this embodiment, the photographic optical device 1 is formed in a substantially square shape when viewed in a direction of an optical axis “L” (optical axis direction) of a photographic lens. Four side faces of the photographic optical device 1 are substantially parallel to the right and left direction or the front and rear direction.

The photographic optical device 1 includes, as shown in FIGS. 1 and 2, a camera module 3 having a lens and an imaging element and being capable of being swung and a shake correction device 4 for correcting a shake for an optical image which is imaged on the imaging element through the lens. In this embodiment, the upper and lower direction is substantially coincided with an optical axis direction of the camera module 3 when the camera module 3 is not swung. Further, in this embodiment, the imaging element is mounted at a lower end of the camera module 3 and an object to be photographed which is located on an upper side is photographed. In other words, in this embodiment, an upper side (“Z1” direction side) is an object to be photographed side (object side) and a lower side (“Z2” direction side) is an opposite-to-object side (imaging element side, image side).

### (Structure of Camera Module)

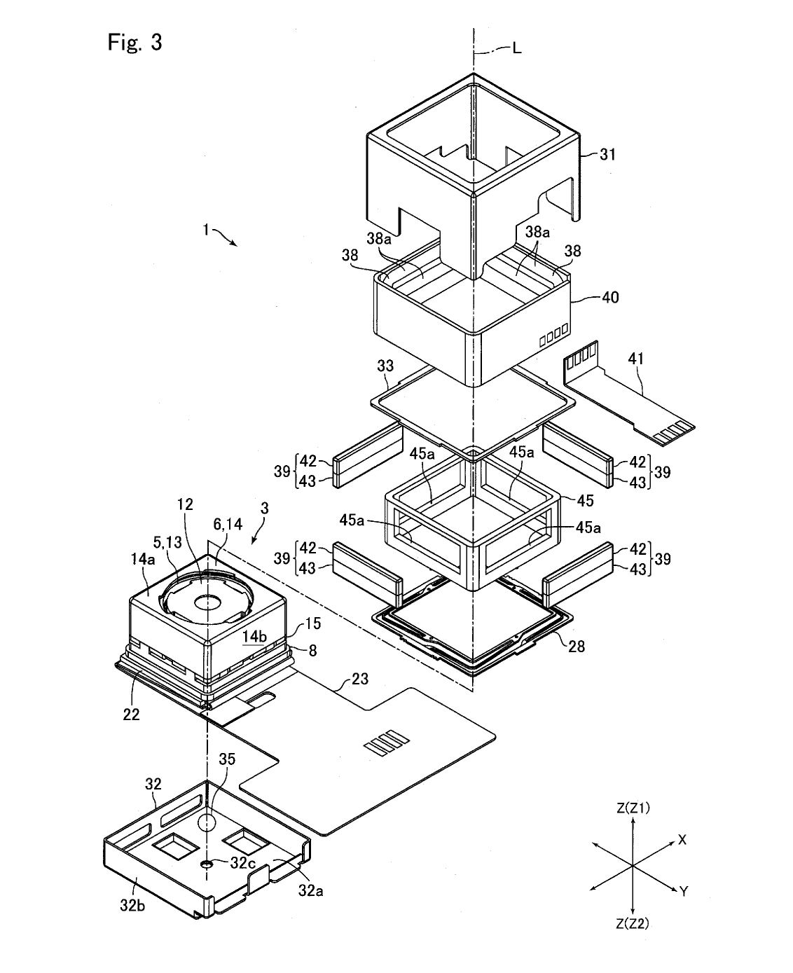

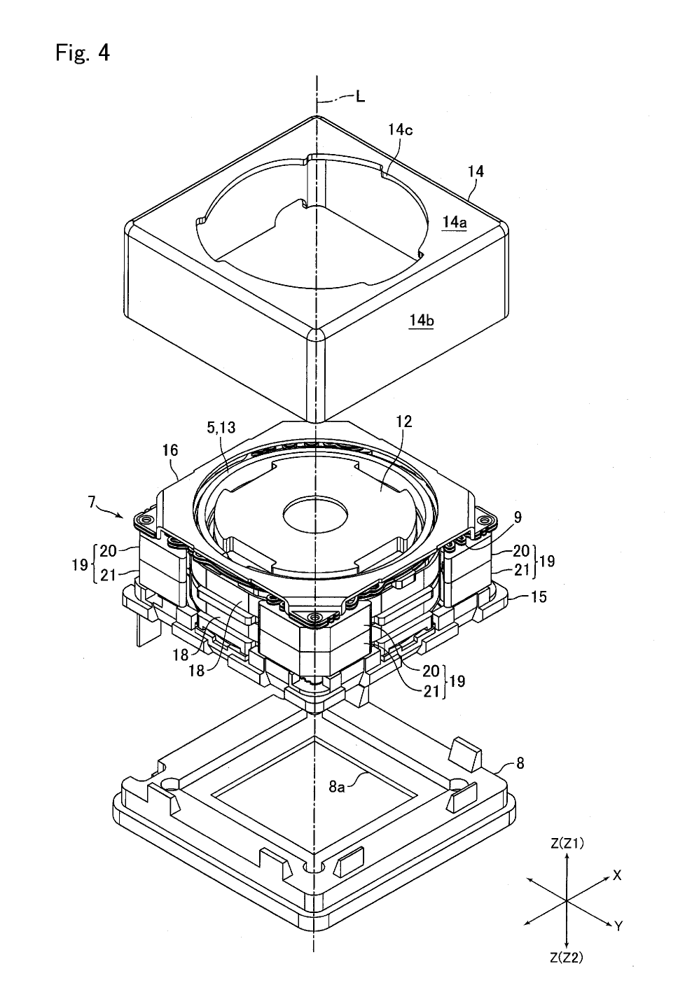

FIG. 3 is an exploded perspective view showing the photographic optical device 1 in FIG. 1. FIG. 4 is an exploded perspective view showing the camera module 3 in FIG. 3.

The camera module 3 is formed in a substantially rectangular prism shape as a whole. In this embodiment, the camera module 3 is formed in a substantially square shape when viewed in the optical axis direction and four side faces of the camera module 3 are substantially parallel to the right and left direction or the front and rear direction.

The camera module 3 includes, as shown in FIGS. 2 and 4, a movable body 5 which holds the lens and is movable in the optical axis direction, a holding body 6 which movably holds the movable body 5 in the optical axis direction, a lens drive mechanism 7 for driving the movable body 5 in the optical axis direction with respect to the holding body 6, and a filter holder 8 holding an “IR” cut filter 11 (see FIG. 2) which cuts a near-infrared light. The movable body 5 is movably held by the holding body 6 through a plate spring 9 (see FIG. 2) disposed on an upper end side of the movable body 5 and a plate spring 10 (see FIG. 2) disposed on a lower end side of the movable body 5. In other words, the movable body 5 and the holding body 6 are connected with each other through the plate springs 9 and 10.

The movable body 5 includes a lens holder 12 to which a plurality of lenses are fixed and a sleeve 13 which holds the lens holder 12. The holding body 6 includes a cover member 14 which structures four side faces (outer peripheral face) of the camera module 3 and a base member 15 which structures an end face on the opposite-to-object side of the camera module 3.

The lens holder 12 is formed in a substantially cylindrical tube shape. A plurality of the lenses is fixed to an inner peripheral side of the lens holder 12. The sleeve 13 is, for example, formed of resin material and is formed in a substantially cylindrical tube shape. The sleeve 13 holds the lens holder 12 on its inner peripheral side. In other words, an outer peripheral face of the lens holder 12 is fixed to an inner peripheral face of the sleeve 13.

The cover member 14 is formed of magnetic material. The cover member 14 is formed in a substantially rectangular tube shape with a bottom (substantially bottomed rectangular tube shape) which is provided with a bottom part 14a and a tube part 14b. The bottom part 14a is disposed on an upper side and structures an end face on the object side of the camera module 3. A circular through hole 14c is formed at the center of the bottom part 14a. The cover member 14 is disposed so as to surround the outer peripheral sides of the movable body 5 and the lens drive mechanism 7. A spacer member 16 is fixed to an under face of the bottom part 14a of the cover member 14 as shown in FIG. 2. The spacer member 16 is formed in a substantially square frame shape. A part of the plate spring 9 is fixed to the spacer member 16.

The base member 15 is formed of resin material and is formed in a substantially square flat plate shape. The base member 15 is fixed to a lower end of the tube part 14b of the cover member 14. A center of the base member 15 is formed with a through hole 15a as shown in FIG. 2. Further, a part of the plate spring 10 is fixed to the base member 15.

The lens drive mechanism 7 is provided with two lens drive coils 18 which are wound around the outer peripheral face of the movable body 5 (specifically, outer peripheral face of the sleeve 13) and four lens drive magnets 19 which are oppositely disposed to the lens drive coils 18.

The two lens drive coils 18 are wound around so that their winding directions are different from each other. For example, one of the lens drive coils 18 is wound around in a clockwise direction in FIG. 4 and the other of the lens drive coils 18 is wound around in a counterclockwise direction in FIG. 4. The two lens drive coils 18 are fixed to the outer peripheral face of the sleeve 13 in a separated state with a predetermined distance therebetween in the upper and lower direction.

The lens drive magnet 19 is formed in a substantially quadrangular prism shape whose shape is a substantially isosceles trapezoid shape when viewed in the optical axis direction. Further, the lens drive magnet 19 is structured of two magnet pieces, i.e., a magnet piece 20 and a magnet piece 21 which are formed in a quadrangular prism shape whose shape is a substantially isosceles trapezoid shape when viewed in the optical axis direction. Specifically, the lens drive magnet 19 is formed so that the magnet piece 20 and the magnet piece 21 are adhesively fixed to each other in a state that an under face of the magnet piece 20 and an upper face of the magnet piece 21 are abutted with each other.

Four lens drive magnets 19 are respectively fixed to inner sides of four corners of the tube part 14b of the cover member 14 so as to face outer peripheral faces of the lens drive coils 18 through a predetermined space. Four magnet pieces 20 are magnetized so that their magnetic poles formed on opposing faces to the lens drive coil 18 are the same. Similarly, four magnet pieces 21 are magnetized so that their magnetic poles formed on opposing faces to the lens drive coil 18 are the same. Further, the magnet pieces 20 and 21 are magnetized so that the magnetic pole of the magnet piece 20 formed on the opposing face to the lens drive coil 18 and the magnetic pole of the magnet piece 21 formed on the opposing face to the lens drive coil 18 are different from each other. In other words, the lens drive magnet 19 is magnetized so that two different magnetic poles are superposed on each other in the upper and lower direction.

The filter holder 8 is formed of resin material and is formed in a substantially square flat plate shape. The filter holder 8 is fixed to an under face of the base member 15. A center of the filter holder 8 is formed with a through hole 8a. Further, the “IR” cut filter 11 is fixed on an upper face side of the filter holder 8.

An imaging element is mounted on the circuit board 22. The circuit board 22 is fixed to an under face of the filter holder 8. The circuit board 22 is mounted with a gyroscope for detecting a variation of inclination of the camera module 3. Further, an FPC (flexible printed circuit board) 23 is connected with the circuit board 22 and the FPC 23 is disposed on a lower end side of the photographic optical device 1 and is extended out from a side face of the photographic optical device 1. Further, an abutting plate 24 which is abutted with a spherical member 35 described below is fixed to the under face of the circuit board 22 as shown in FIG. 2.

### (Structure of Shake Correction Device)

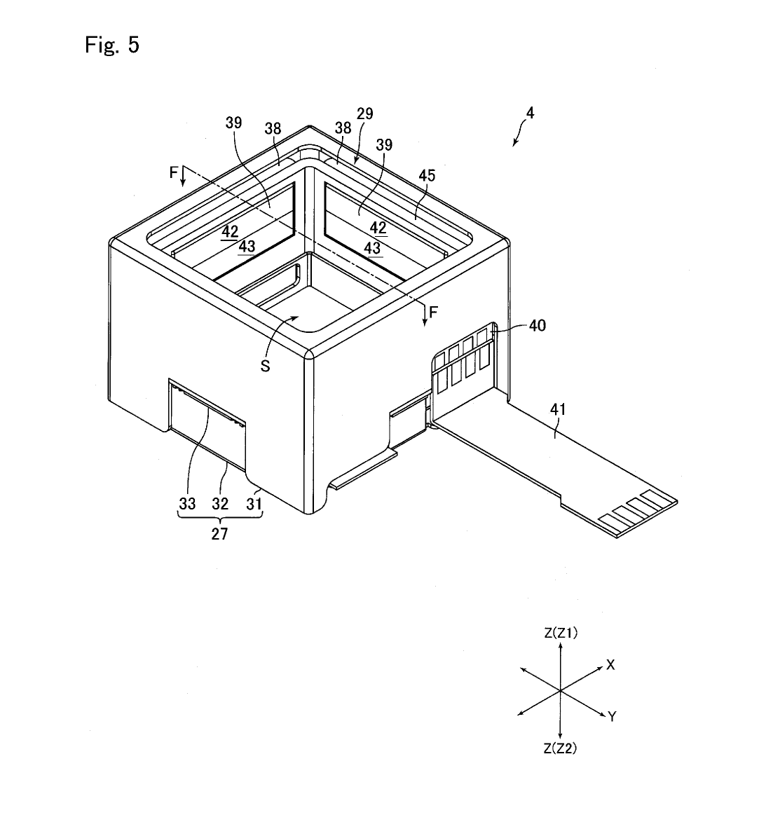

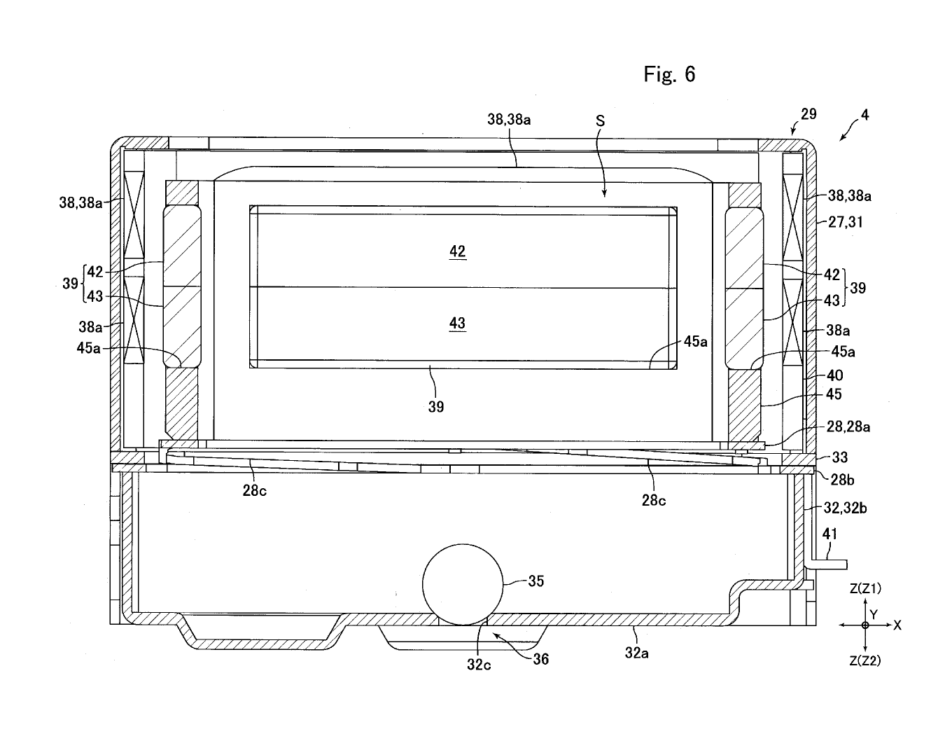

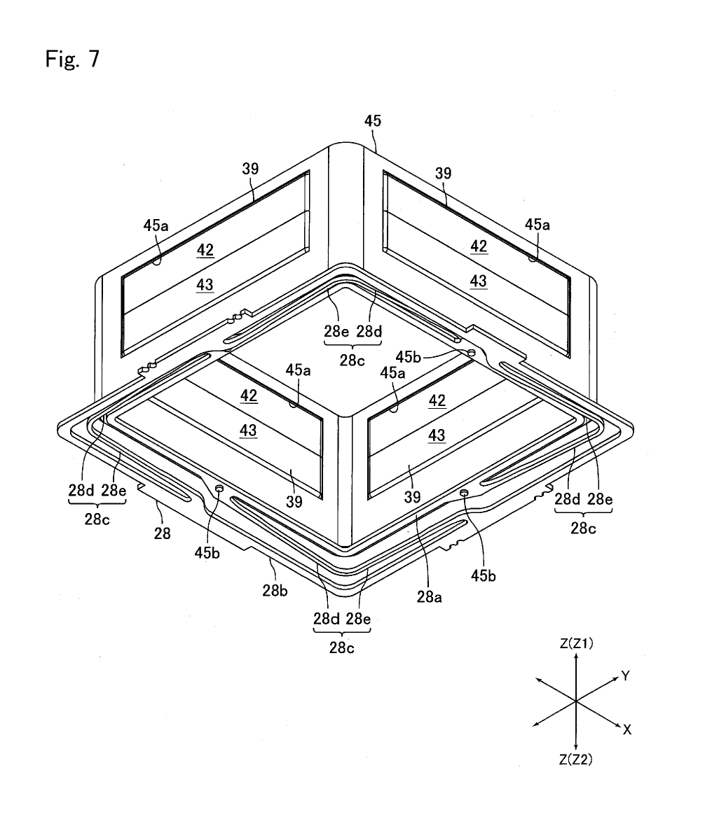

FIG. 5 is a perspective view showing the shake correction device 4 in FIG. 1. FIG. 6 is a cross-sectional view showing the “F-F” cross section in FIG. 5. FIG. 7 is a perspective view showing an assembled state of a plate spring 28, shake correction magnets 39 and a magnet holder 45 shown in FIG. 3, which is viewed from an opposite-to-object side.

The shake correction device 4 includes a support body 27 for swingably supporting the camera module 3, a plate spring 28 as a spring member for connecting the camera module 3 with the support body 27, and a swing drive mechanism 29 which swings the camera module 3 with respect to the support body 27 for correcting a shake such as a shake in the hand.

The support body 27 includes a case body 31 which structures four side faces (outer peripheral face) in the front and rear direction and the right and left direction of the photographic optical device 1, a lower case body 32 as an opposite-to-object side case body which structures an under face side of the photographic optical device 1, and a spacer member 33 as a fixing member for fixing a part of the plate spring 28. The case body 31 is formed in a substantially rectangular tube shape and is disposed so as to surround the camera module 3 from its outer peripheral side. The lower case body 32 is formed in a substantially rectangular tube shape with a bottom (substantially bottomed rectangular tube shape) which is provided with a bottom part 32a and a tube part 32b. The spacer member 33 is formed in a substantially square frame shape.

The bottom part 32a of the lower case body 32 is disposed on a lower side and structures an under face of the photographic optical device 1. Further, a center of the bottom part 32a is formed with a disposing hole 32c in a circular shape in which a lower end side of a spherical member 35 that serves as a supporting point for swinging of the camera module 3 is disposed. In this embodiment, the supporting point part 36 which is a swing center for the camera module 3 is structured of the spherical member 35 and the disposing hole 32c. The supporting point part 36 is disposed on a lower side with respect to the camera module 3 and an upper end of the spherical member 35 is abutted with an under face of the abutting plate 24. The spherical member 35 in this embodiment is a support-point protruded part structuring the supporting point part 36 and an edge of the disposing hole 32c is an abutting part with which the spherical member 35 that is a support-point protruded part is abutted.

The swing drive mechanism 29 includes four shake correction coils 38 and four shake correction magnets 39 which are respectively oppositely disposed to the four shake correction coils 38.

The four shake correction coils 38 are mounted and formed on an FPC 40 as shown in FIG. 3. Further, the shake correction coil 38 is formed so as to be wound around in a substantially rectangular shape and is provided with two long side parts 38a which are substantially parallel to each other. The FPC 40 is disposed along the inner peripheral face of the case body 31 so that each of the four shake correction coils 38 is disposed on each of four inner side faces which structure the inner peripheral face of the case body 31. Further, the FPC 40 is fixed to the inner peripheral face of the case body 31 so that the long side part 38a is substantially parallel to the front and rear direction or the right and left direction (in other words, the short side direction of the shake correction coil 38 wound around in a substantially rectangular shape is substantially coincided with the upper and lower direction). The FPC 40 is connected with an FPC 23 through a relaying FPC 41. In accordance with an embodiment of the present invention, the shake correction coil 38 may be an air-core coil which is wound around in an air-core shape.

The shake correction magnet 39 is formed in a substantially rectangular flat plate shape. Further, the shake correction magnet 39 is structured of two magnet pieces, i.e., a magnet piece 42 and a magnet piece 43 which are formed in a substantially rectangular flat plate shape. Specifically, the shake correction magnet 39 is formed by adhesively fixing the magnet piece 42 and the magnet piece 43 to each other in a state that an under face of the magnet piece 42 and an upper face of the magnet piece 43 are abutted with each other.

The four shake correction magnets 39 are held by the magnet holder 45. The magnet holder 45 is, for example, formed of resin material. Further, the magnet holder 45 is formed in a substantially rectangular tube shape. Each of four side faces of the magnet holder 45 is formed with a fixing hole 45a in a substantially rectangular shape so as to penetrate through the side face for fixing the shake correction magnet 39. Further, respective lower end faces of four side faces of the magnet holder 45 are formed with a positioning projection 45b as a positioning part for positioning a magnet holding part 28a described below, which structures the plate spring 28, in the front and rear direction and the right and left direction as shown in FIG. 7.

The shake correction magnet 39 is fixed to the fixing hole 45a so that its thickness direction is coincided with a thickness direction of a side face of the magnet holder 45 and its longitudinal direction is substantially coincided with the right and left direction or the front and rear direction (in other words, its short side direction is substantially coincided with the upper and lower direction). In other words, the magnet holder 45 holds both end sides of the shake correction magnet 39 in the right and left direction or the front and rear direction and, in addition, the magnet holder 45 holds both end sides of the shake correction magnet 39 in the upper and lower direction. Further, inner side faces of the shake correction magnets 39 in the front and rear direction and the right and left direction are capable of being fixed to the outer peripheral face of the tube part 14b of the cover member 14, and the shake correction magnets 39 are disposed on an inner peripheral side of the case body 31 with respect to the shake correction coils 38.

The magnet piece 42 is magnetized so that a magnetic pole formed on one side face and a magnetic pole formed on the other side face are different from each other. In other words, the magnet pieces 42 are magnetized so that their magnetic poles formed on the inner side faces fixed to the tube part 14b in the front and rear direction and the right and left direction are different from their magnetic poles formed on their outer side faces in the front and rear direction and the right and left direction which are oppositely disposed to the shake correction coils 38. Similarly, the magnet pieces 43 are magnetized so that their magnetic poles formed on the inner side faces fixed to the tube part 14b in the front and rear direction and the right and left direction are different from their magnetic poles formed on their outer side faces in the front and rear direction and the right and left direction which are oppositely disposed to the shake correction coils 38. Further, the magnet pieces 42 and 43 are magnetized so that the magnetic pole on the inner side face of the magnet piece 42 and the magnetic pole on the inner side face of the magnet piece 43 are different from each other. In other words, the magnet pieces 42 and 43 are magnetized so that the magnetic pole of the outer side face of the magnet piece 42 and the magnetic pole of the outer side face of the magnet piece 43 are different from each other.

The plate spring 28 is, as shown in FIG. 7, provided with a magnet holding part 28a which holds the shake correction magnet 39, a support body fixing part 28b which is fixed to the support body 27, and four spring parts 28c which connect the magnet holding part 28a with the support body fixing part 28b. In this embodiment, the spring parts 28c are resiliently bent with respect to the support body fixing part 28b and thus, the camera module 3 which is fixed to the magnet holding part 28a through the shake correction magnet 39 and the like is capable of performing a swing operation.

The magnet holding part 28a and the support body fixing part 28b are formed in a ring shape. Specifically, the magnet holding part 28a and the support body fixing part 28b are formed in a substantially square frame shape. The support body fixing part 28b is formed larger than the magnet holding part 28a and is disposed on an outer peripheral side with respect to the magnet holding part 28a. The spring part 28c is disposed between the magnet holding part 28a and the support body fixing part 28b. Further, the spring part 28c is formed in a substantially “L”-shape. Specifically, the spring part 28c is, as shown in FIG. 7, formed in a substantially “L”-shape which is structured of an inner side spring part 28d in a straight line shape that is connected with the magnet holding part 28a and an outer side spring part 28e that is connected with the support body fixing part 28b.

The magnet holder 45 is fixed to the magnet holding part 28a. Specifically, a lower end face of the magnet holder 45 is fixed to an upper face of the magnet holding part 28a. The magnet holding part 28a is formed with a through hole into which the positioning projection 45b of the magnet holder 45 is inserted and the magnet holder 45 is fixed to the magnet holding part 28a in a positioned state in the front and rear direction and the right and left direction.

The support body fixing part 28b is, as shown in FIGS. 2 and 6, fixed to the tube part 32b and the spacer member 33 in a state that the support body fixing part 28b is sandwiched between an upper end of the tube part 32b of the lower case body 32 and an under face of the spacer member 33. In other words, the under face of the support body fixing part 28b is abutted with the upper end of the tube part 32b. Further, the spacer member 33 is fixed to the lower end of the case body 31 and the lower case body 32 is fixed to the lower end side of the case body 31 in a state that the lower case body 32 is disposed on a lower side with respect to the spacer member 33 through the support body fixing part 28b. In this embodiment, the upper end of the tube part 32b and the under face of the spacer member 33 are formed with no positioning part for positioning the support body fixing part 28b in the front and rear direction and the right and left direction.

The plate spring 28 is fixed in a resiliently bent state so that pressurization is generated for surely abutting the upper end of the spherical member 35 with the abutting plate 24 and for surely abutting the lower end side of the spherical member 35 with the edge of the disposing hole 32c of the lower case body 32 (in other words, so as to generate an urging force for urging the camera module 3 to the lower direction). In other words, as shown in FIGS. 2 and 6, the support body fixing part 28b is fixed to the support body 27 at a lower position with respect to the magnet holding part 28a and the support body fixing part 28b is disposed on a lower side with respect to the magnet holding part 28a.

Further, the plate spring 28 is fixed so that its inner side spring part 28d and its outer side spring part 28e are substantially parallel to the front and rear direction or the right and left direction. The spring part 28c in this embodiment is structured of the inner side spring part 28d or the outer side spring part 28e which is substantially parallel to the right and left direction and the inner side spring part 28d or the outer side spring part 28e which is substantially parallel to the front and rear direction and is structured to be capable of deforming in the right and left direction and the front and rear direction. Further, the spring part 28c in this embodiment is capable of deforming in the upper and lower direction.

As described above, the magnet holder 45 which holds the shake correction magnets 39 is fixed to the magnet holding part 28a of the plate spring 28. Therefore, even in a state that the shake correction magnets 39 are not fixed to the tube part 14b of the cover member 14, the shake correction magnets 39 are connected with the support body 27 through the magnet holder 45 and the plate spring 28. In the shake correction device 4 in a state that the camera module 3 is not attached, as shown in FIG. 5, an accommodating space “S” in which the camera module 3 is capable of being disposed is formed on an inner peripheral side with respect to the shake correction magnet 39.

### (Schematic Operation of Photographic Optical Device)

In the photographic optical device 1 structured as described above, when an electric current is supplied to the lens drive coils 18, the lens is moved in the optical axis direction together with the movable body 5. Further, in the photographic optical device 1, when a variation of inclination of the camera module 3 is detected by a gyroscope which is mounted on the circuit board 22, an electric current is supplied to the shake correction coils 38 based on the detection result of the gyroscope. When the electric current is supplied to the shake correction coils 38, the camera module 3 is swung so that the optical axis “L” is inclined with the supporting point part 36 as a swing center and with the front and rear direction and/or the right and left direction as an axial direction to correct the shake.

In this embodiment, the shake correction mechanism which swings the camera module 3 so that the optical axis “L” inclines with respect to the support body 27 for correcting a shake is structured of the plate spring 28, the swing drive mechanism 29, the supporting point part 36 and the like.

### (Assembling Procedure of Photographic Optical Device)

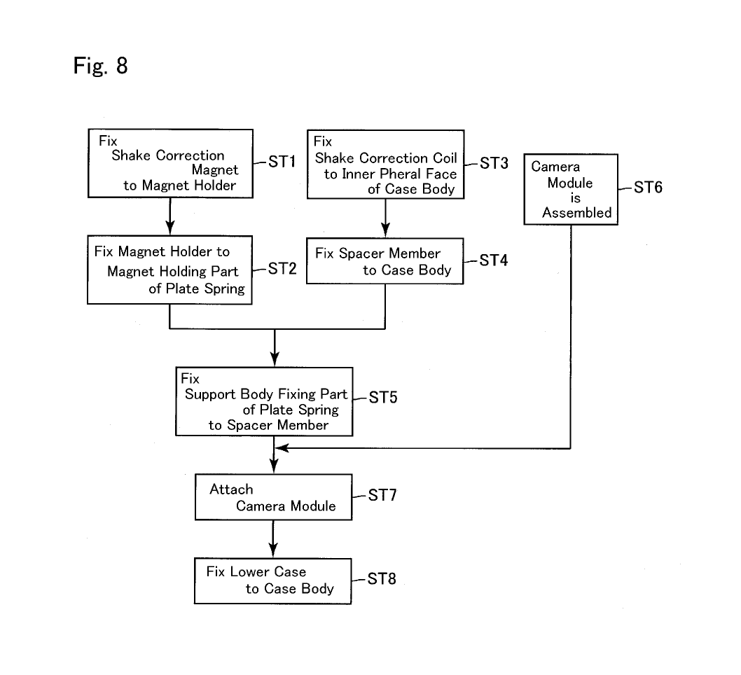

FIG. 8 is a process chart showing an assembling procedure for the photographic optical device 1 shown in FIG. 1.

The photographic optical device 1 is, for example, assembled in the following procedures. In other words, as shown in FIG. 8, first, the shake correction magnets 39 are fixed to the fixing holes 45a of the magnet holder 45 (step ST1). After that, the magnet holder 45 is fixed to the magnet holding part 28a of the plate spring 28 (step ST2). Further, the shake correction coils 38 are fixed to the inner peripheral face of the case body 31 (step ST3). In other words, the FPC 40 is fixed to the inner peripheral face of the case body 31. After that, the spacer member 33 is fixed to the lower end of the case body 31 (step ST4).

After the steps ST2 and ST4, the magnet holder 45 to which the shake correction magnets 39 are fixed is inserted into an inner peripheral side with respect to the case body 31 from a lower side and the support body fixing part 28b of the plate spring 28 is fixed to the under face of the spacer member 33 (step ST5). Further, the camera module 3 is assembled (step ST6) and, after the step ST5, the camera module 3 is inserted into an inner side of the shake correction magnets 39 and is fixed to the shake correction magnets 39 (step ST7). After that, the lower case body 32 is fixed to the lower end side of the case body 31 in a state that the spherical member 35 is disposed on the disposing hole 32c (step ST8) and the photographic optical device 1 is completed.

Next, a second embodiment for solving the above-mentioned problem will be described below.

### (Schematic Structure of Photographic Optical Device)

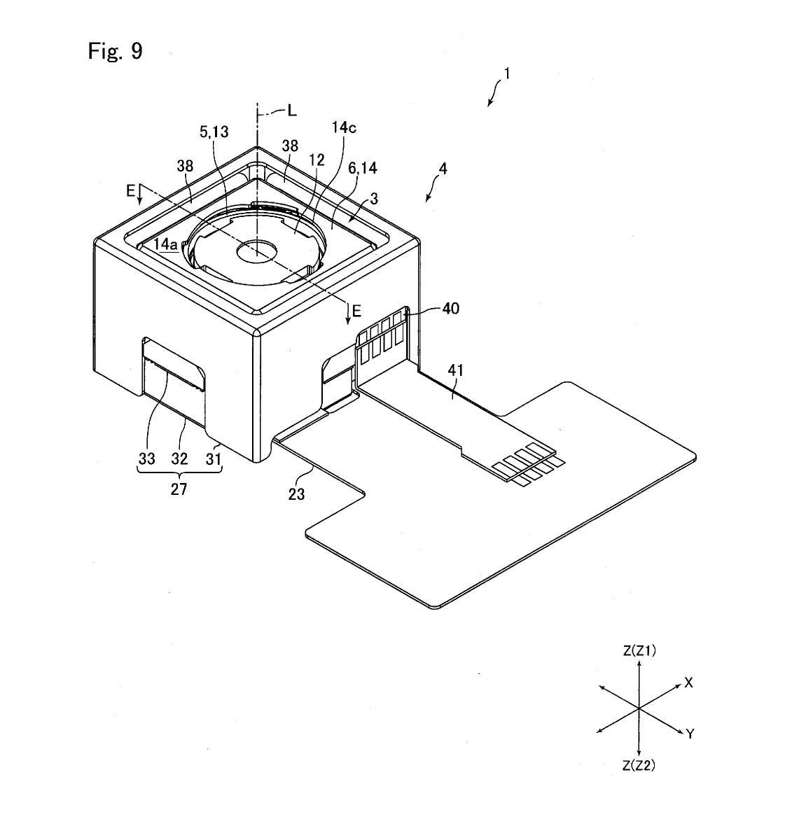

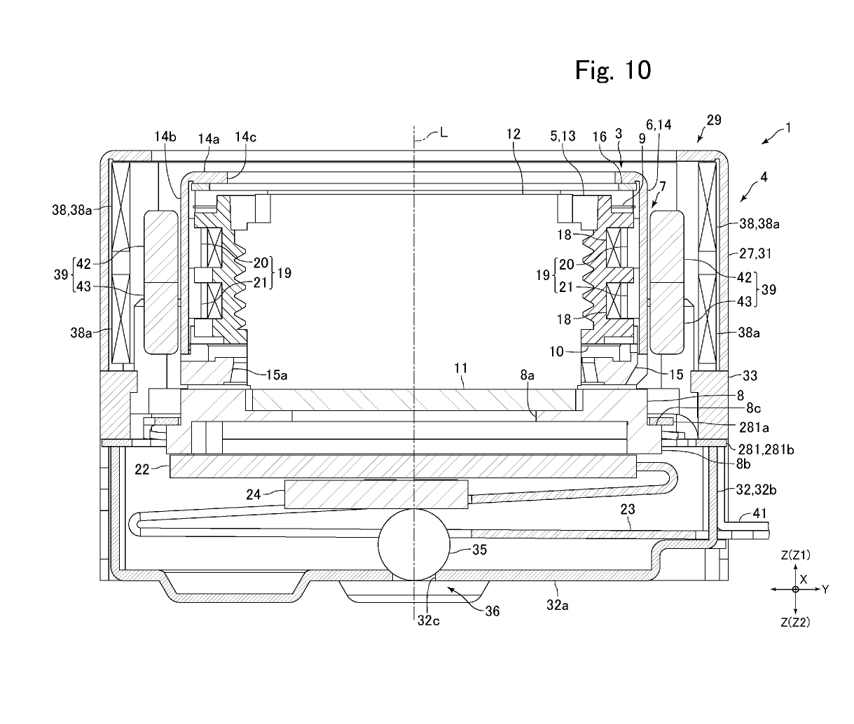

FIG. 9 is a perspective view showing a photographic optical device 1 in accordance with a second embodiment of the present invention. FIG. 10 is a cross-sectional view showing the “E-E” cross section in FIG. 9. The second embodiment is similar to the first embodiment shown in FIGS. 1 through 4 except the following description and their similar descriptions are omitted. Further, in the second embodiment, the right and left direction is a first direction substantially perpendicular to the optical axis direction and the front and rear direction is a second direction substantially perpendicular to the optical axis direction and the first direction.

### (Structure of Camera Module)

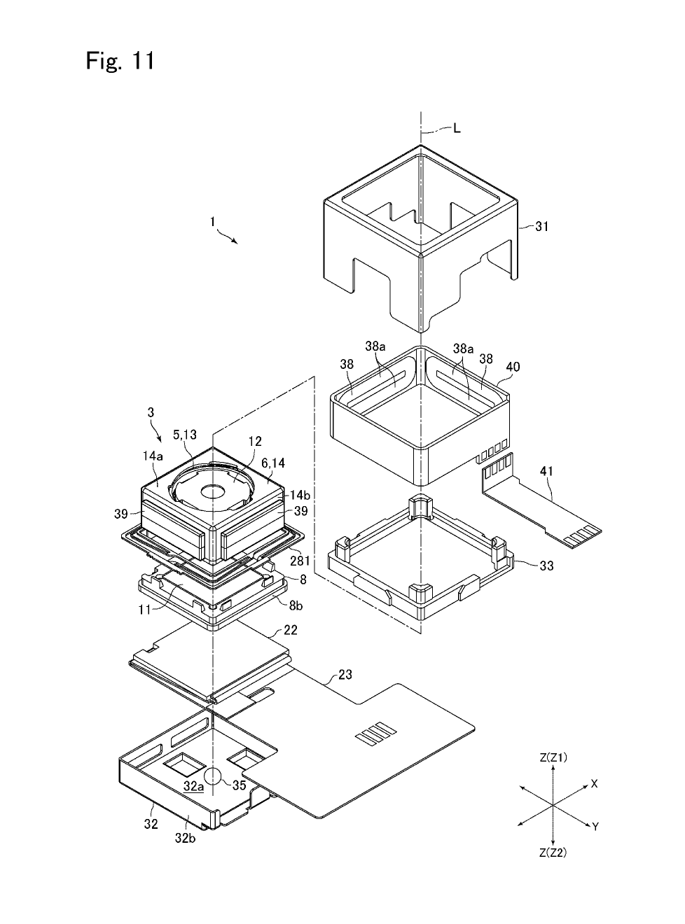

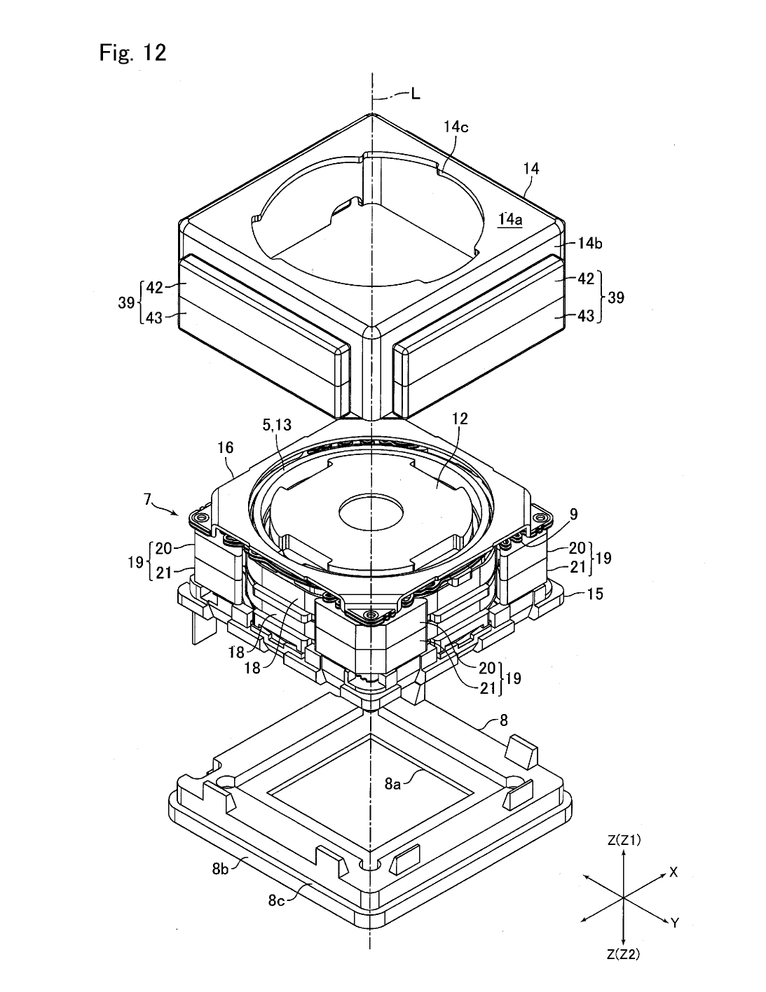

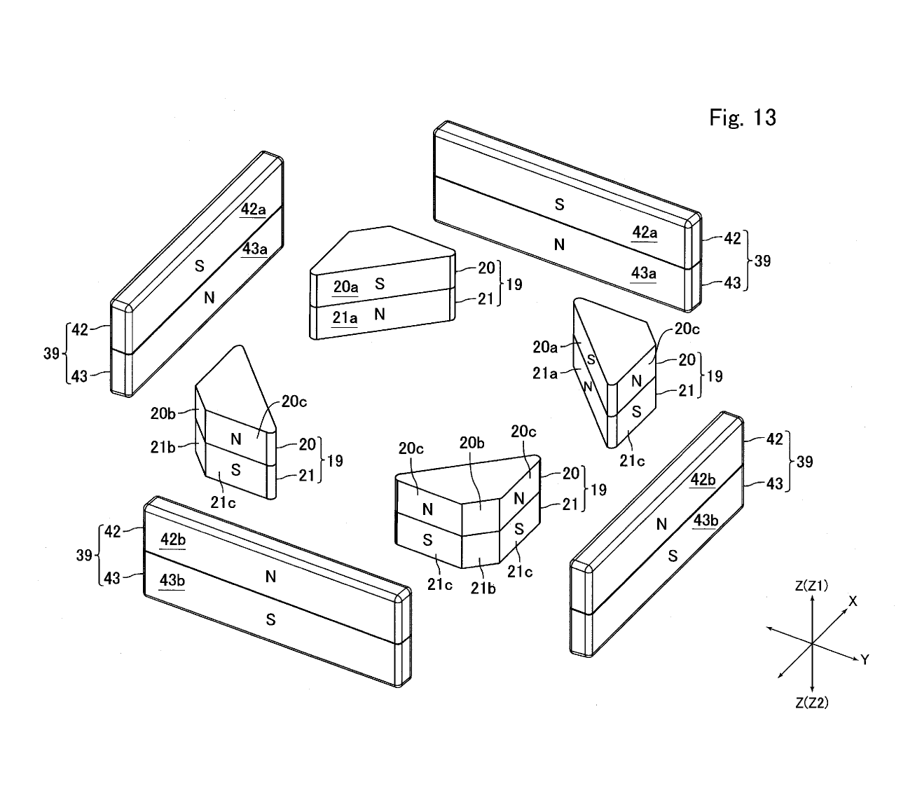

FIG. 11 is an exploded perspective view showing the photographic optical device 1 in FIG. 9. FIG. 12 is an exploded perspective view showing a camera module 3 in FIG. 11. FIG. 13 is an explanatory perspective view showing magnetized states of lens drive magnets 19 and shake correction magnets 39 shown in FIG. 10.

The lens drive magnet 19 is, as shown in FIG. 13, formed in a substantially quadrangular prism shape whose shape is a substantially isosceles trapezoid shape when viewed in the optical axis direction.

A magnet piece 20 is provided with a first flat face 20a, a second flat face 20b which is substantially parallel to the first flat face 20a and whose area is smaller than that of the first flat face 20a, and two oblique flat faces 20c which are inclined with respect to the first flat face 20a and the second flat face 20b so as to be widened from the second flat face 20b toward the first flat face 20a. Similarly, a magnet piece 21 is provided with a first flat face 21a, a second flat face 21b which is substantially parallel to the first flat face 21a and whose area is smaller than that of the first flat face 21a, and two oblique flat faces 21c which are inclined with respect to the first flat face 21a and the second flat face 21b so as to be widened from the second flat face 21b toward the first flat face 21a.

Four lens drive magnets 19 are fixed to an inner peripheral face of the tube part 14b of the cover member 14. Specifically, the four lens drive magnets 19 are fixed to respective inner sides of four corners of the tube part 14b so that two oblique flat faces 20c and 21c are substantially parallel to the right and left direction or the front and rear direction. In other words, the four lens drive magnets 19 are fixed to the respective inner sides of four corners of the tube part 14b so that the first flat faces 20a and 21a of the lens drive magnets 19 disposed on diagonal lines of the tube part 14b are faced each other. The first flat faces 20a and 21a are oppositely disposed to the outer peripheral faces of the lens drive coils 18 through a predetermined gap space.

The four magnet pieces 20 are magnetized so that the magnetic poles formed on the first flat faces 20a are the same as each other. Further, the four magnet pieces 20 are magnetized so that the magnetic poles formed on the oblique flat faces 20c are the same as each other and that the magnetic poles formed on the oblique flat faces 20c and the magnetic poles formed on the first flat faces 20a are different from each other. Similarly, the four magnet pieces 21 are magnetized so that the magnetic poles formed on the first flat faces 21a are the same as each other. Further, the four magnet pieces 21 are magnetized so that the magnetic poles formed on the oblique flat faces 21c are the same as each other and that the magnetic poles formed on the oblique flat faces 21c and the magnetic poles formed on the first flat faces 21a are different from each other.

Further, the magnet pieces 20 and 21 are magnetized so that the magnetic pole of the first flat face 20a and the magnetic pole of the first flat face 21a are different from each other, and that the magnetic pole of the oblique flat face 20c and the magnetic pole of the oblique flat face 21c are different from each other. In other words, the lens drive magnet 19 is magnetized so that two different magnetic poles are superposed on each other in the upper and lower direction. For example, the magnet pieces 20 and 21 are magnetized so that the magnetic pole of the first flat face 20a is an “S”-pole, the magnetic pole of the first flat face 21a is an “N”-pole, the magnetic pole of the oblique flat face 20c is an “N”-pole, and the magnetic pole of the oblique flat face 21c is an “S”-pole.

An outer peripheral side of the filter holder 8 is formed with a spring fixing protruded part 8b, to which a part of a plate spring 281 structuring the shake correction device 4 is fixed, so as to extend to the front and rear direction and the right and left direction. The spring fixing protruded part 8b is formed in the entire periphery of the filter holder 8.

### (Structure of Shake Correction Device)

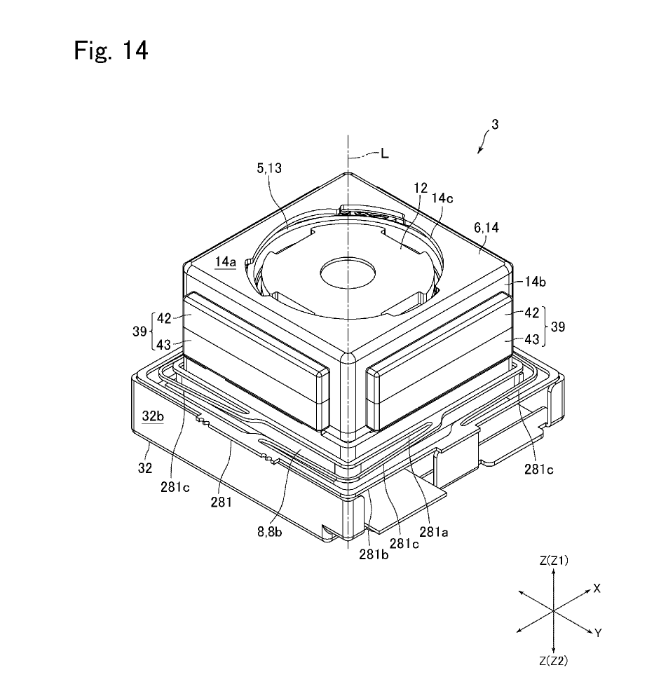

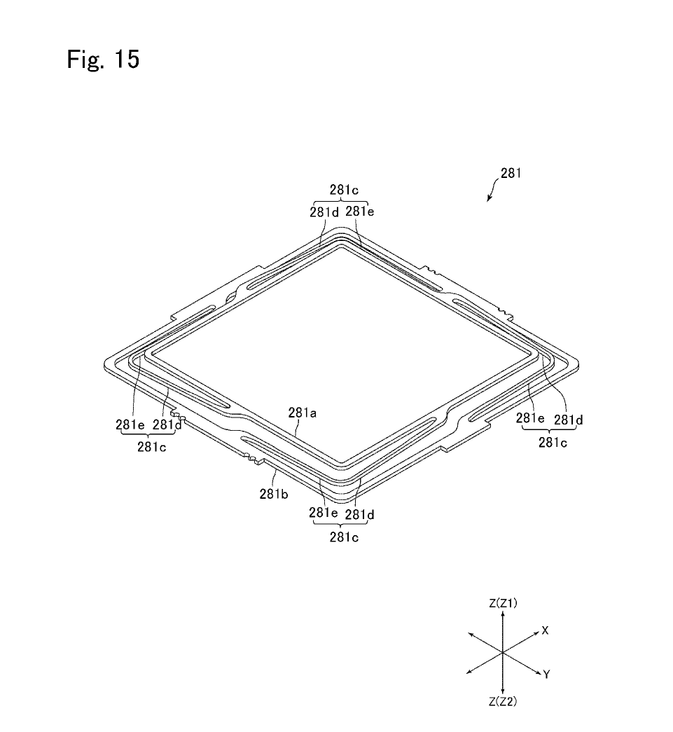

FIG. 14 is an explanatory perspective view showing an arrangement relationship of the camera module 3, the plate spring 281 and the lower case body 32 shown in FIG. 10. FIG. 15 is a perspective view showing the plate spring 281 in FIG. 11.

The plate spring 281 is, as shown in FIG. 15, provided with a movable side fixing part 281a fixed to the camera module 3, a fixed side fixing part 281b fixed to the support body 27, and four spring parts 281c which connects the movable side fixing part 281a with the fixed side fixing part 281b. In this embodiment, the spring parts 281c are resiliently bent with respect to the fixed side fixing part 281b and thus, the camera module 3 fixed to the movable side fixing part 281a is capable of performing a swing operation.

The movable side fixing part 281a and the fixed side fixing part 281b are formed in a ring shape. Specifically, the movable side fixing part 281a and the fixed side fixing part 281b are formed in a substantially square frame shape. The fixed side fixing part 281b is formed larger than the movable side fixing part 281a and is disposed on an outer peripheral side of the movable side fixing part 281a. The spring parts 281c are disposed between the movable side fixing part 281a and the fixed side fixing part 281b. Further, the spring part 281c is formed in a substantially “L”-shape. Specifically, the spring part 281c is, as shown in FIG. 15, formed in a substantially “L”-shape which is structured of an inner side spring part 281d in a straight line shape that is connected with the movable side fixing part 281a and an outer side spring part 281e that is connected with the fixed side fixing part 281b.

The movable side fixing part 281a is directly fixed to the camera module 3. Specifically, as shown in FIG. 10, an under face of the movable side fixing part 281a is fixed to an upper face 8c of the spring fixing protruded part 8b of the filter holder 8. The fixed side fixing part 281b is, as shown in FIG. 10, fixed to the tube part 32b and the spacer member 33 in a state that the fixed side fixing part 281b is sandwiched between the upper end of the tube part 32b of the lower case body 32 and the under face of the spacer member 33. In other words, as shown in FIGS. 10 and 14, the under face of the fixed side fixing part 281b is abutted with the upper end of the tube part 32b. Further, the lower case body 32 is fixed to the lower end side of the case body 31 and the spacer member 33 is fixed to the case body 31 in a state that the spacer member 33 is disposed on an upper side of the lower case body 32 through the fixed side fixing part 281b.

The plate spring 281 is fixed in a resiliently bent state so that pressurization is generated for surely abutting the upper end of the spherical member 35 with the abutting plate 24 and for surely abutting the lower end side of the spherical member 35 with the edge of the disposing hole 32c of the lower case body 32 (in other words, so as to generate an urging force for urging the camera module 3 to the lower direction). In other words, as shown in FIGS. 10 and 14, the fixed side fixing part 281b is fixed to the support body 27 at a lower position with respect to the movable side fixing part 281a and the fixed side fixing part 281b is disposed on a lower side with respect to the movable side fixing part 281a.

Further, the plate spring 281 is fixed so that its inner side spring part 281d and its outer side spring part 281e are substantially parallel to the front and rear direction or the right and left direction. In this embodiment, the inner side spring part 281d and the outer side spring part 281e which are substantially parallel to the right and left direction are a first spring part and the inner side spring part 281d and the outer side spring part 281e which are substantially parallel to the front and rear direction are a second spring part. In other words, the spring part 281c in this embodiment is structured of the first spring part which is substantially parallel to the right and left direction and the second spring part which is substantially parallel to the front and rear direction and is capable of deforming in the right and left direction and the front and rear direction. Further, the spring part 281c in this embodiment is also capable of deforming in the upper and lower direction.

The shake correction magnet 39 is formed in a substantially rectangular flat plate shape. Each of four shake correction magnets 39 is fixed to each of four outer side faces which structure the outer peripheral face of the tube part 14b of the cover member 14. In other words, the shake correction magnets 39 are directly fixed to the outer peripheral face of the camera module 3. Specifically, the shake correction magnets 39 are fixed to the outer side faces of the tube part 14b so that its thickness direction is coincided with a thickness direction of the tube part 14b and its longitudinal direction is substantially coincided with the right and left direction or the front and rear direction (in other words, its short side direction is substantially coincided with the upper and lower direction).

The magnet piece 42 is magnetized so that a magnetic pole formed on one side face and a magnetic pole formed on the other side face are different from each other. In other words, the magnet pieces 42 are magnetized so that magnetic poles formed on the inner side faces 42a (see FIG. 13) which are fixed to the tube part 14b in the front and rear direction and the right and left direction are different from magnetic poles formed on the outer side faces 42b (see FIG. 13) which face the shake correction coils 38 in the front and rear direction and the right and left direction. Further, the four magnet pieces 42 are magnetized so that the magnetic poles formed on the outer side faces 42b are the same as each other (in other words, the magnetic poles formed on the inner side faces 42a are the same as each other).

Similarly, the magnet pieces 43 are magnetized so that magnetic poles formed on the inner side faces 43a (see FIG. 13) which are fixed to the tube part 14b in the front and rear direction and the right and left direction are different from magnetic poles formed on the outer side faces 43b (see FIG. 13) which face the shake correction coils 38 in the front and rear direction and the right and left direction. Further, the four magnet pieces 43 are magnetized so that the magnetic poles formed on the outer side faces 43b are the same as each other (in other words, the magnetic poles formed on the inner side faces 43a are the same as each other).

Further, the magnet pieces 42 and 43 are magnetized so that the magnetic pole on the inner side face 42a and the magnetic pole on the inner side face 43a are different from each other. In other words, the magnet pieces 42 and 43 are magnetized so that the magnetic pole of the outer side face 42b and the magnetic pole of the outer side face 43b are different from each other.

In addition, the magnet piece 42 is magnetized so that the magnetic pole of the oblique flat face 20c of the magnet piece 20 which structures the lens drive magnet 19 is different from the magnetic pole of the inner side face 42a and the magnet piece 43 is magnetized so that the magnetic pole of the oblique flat face 21c of the magnet piece 21 which structures the lens drive magnet 19 is different from the magnetic pole of the inner side face 43a. For example, the magnet pieces 42 and 43 are magnetized so that the inner side face 42a is an “S”-pole, the inner side face 43a is an “N”-pole, the outer side face 42b is an “N”-pole, and the outer side face 43b is an “S”-pole.

Further, in this embodiment, the lens drive magnets 19 and the shake correction magnets 39 are structured so that both end sides in the right and left direction or the front and rear direction of the shake correction magnets 39 are oppositely faced to the oblique flat faces 20c and 21c of the lens drive magnets 19 through the tube part 14b of the cover member 14. In other words, in this embodiment, the lens drive magnet 19 and the shake correction magnet 39 are fixed to the tube part 14b so that the magnetic pole of the oblique flat face 20c of the oblique flat faces 20c and 21c which are the opposing face of the lens drive magnet 19 to the shake correction magnet 39 through the tube part 14b is different from the magnetic pole of the inner side face 42a of the inner side faces 42a and 43a which are the opposing face of the shake correction magnet 39 to the lens drive magnet 19 through the tube part 14b. (In other words, the lens drive magnet 19 and the shake correction magnet 39 are fixed to the tube part 14b so that the magnetic pole of the oblique flat face 21c of the oblique flat faces 20c and 21c is different from the magnetic pole of the inner side face 43a of the inner side faces 42a and 43a). In this embodiment, the oblique flat faces 20c and 21c are a first opposing face and the inner side faces 42a and 43a are a second opposing face.

(Principal Effects in this Embodiment)

As described above, in the first embodiment, the shake correction coil 38 is fixed to the inner peripheral face of the case body 31, which structures the support body 27, and the support body fixing part 28b of the plate spring 28 is fixed to the spacer member 33 which structures the support body 27. Further, in this embodiment, the shake correction magnet 39 is held by the magnet holding part 28a of the plate spring 28 through the magnet holder 45. In addition, in this embodiment, an accommodating space “S” in which the camera module 3 is capable of being disposed is formed on an inner peripheral side of the shake correction magnets 39.

Therefore, in this embodiment, as described above, the shake correction coils 38 and the shake correction magnets 39 are integrated with each other through the case body 31, the spacer member 33, the plate spring 28 and the magnet holder 45 before the camera module 3 is incorporated into the accommodating space “S”. Accordingly, in this embodiment, influence of dimensional accuracy and assembling accuracy of the camera module 3 exerted upon the relative positional accuracy between the shake correction coil 38 and the shake correction magnet 39 is reduced and, as a result, the relative positional accuracy between the shake correction coil 38 and the shake correction magnet 39 can be enhanced in comparison with the conventional structure. For example, in this embodiment, accuracy of the gap space between the shake correction coil 38 and the shake correction magnet 39 can be further enhanced and, as a result, a correcting function for a shake by the shake correction device 4 can be enhanced.

Further, in this embodiment, the shake correction coils 38 and the shake correction magnets 39 are integrated with each other through the case body 31, the spacer member 33, the plate spring 28 and the magnet holder 45 before the camera module 3 is incorporated. Therefore, both of the shake correction device 4 in a state that the camera module 3 is not incorporated yet and the shake correction device 4 in a state that the camera module 3 has been incorporated (in other words, the photographic optical device 1) can be distributed in the market. Accordingly, in this embodiment, distribution of the shake correction device 4 can be diversified.

In this embodiment, the four shake correction magnets 39 are fixed to the magnet holder 45 and the magnet holder 45 is fixed to the magnet holding part 28a. Therefore, the four shake correction magnets 39 are integrated with each other through the magnet holder 45. Accordingly, relative positional accuracy between the four shake correction magnets are enhanced and, as a result, the relative position accuracy between the shake correction coil 38 and the shake correction magnet 39 is enhanced effectively. Further, the four shake correction magnets 39 are integrated with each other through the magnet holder 45 and thus, even in a state that the camera module 3 is not incorporated, the shake correction magnets 39 can be stabilized. Further, when the photographic optical device 1 is to be assembled, handling of the shake correction magnets 39 is easy in comparison with a case that four shake correction magnets 39 are handled individually.

In this embodiment, the magnet holder 45 is formed with the positioning projection 45b for positioning the magnet holding part 28a. Therefore, relative positional accuracies in the front and rear direction and the right and left direction between the magnet holding part 28a and the magnet holder 45 are enhanced and, as a result, the relative positional accuracies in the front and rear direction and the right and left direction between the shake correction coils 38 and the shake correction magnets 39 are enhanced effectively.

In this embodiment, the magnet holder 45 holds both ends of the shake correction magnet 39 in the right and left direction or the front and rear direction and both ends of the shake correction magnet 39 in the upper and lower direction. Therefore, rigidity of the magnet body structured of the four shake correction magnets 39 and the magnet holder 45 is enhanced.

In this embodiment, the shake correction device 4 is provided with the supporting point part 36 which is a swing center for the camera module 3. Therefore, instead of incorporating the camera module 3, inspection of the shake correcting function can be performed by incorporating a dummy module for inspection. In this case, the dummy module is temporarily fixed by utilizing an attraction force of the shake correction magnets 39 and thus, even in a state that an axial direction of the dummy module is inclined with respect to the vertical direction, inspection of the shake correcting function can be performed. In other words, the inspection of the shake correcting function can be performed in all postures.

In this embodiment, the support body fixing part 28b of the plate spring 28 is fixed to the support body 27 at a lower position with respect to the magnet holding part 28a. Therefore, the camera module 3 is urged toward the supporting point part 36 which is disposed on a lower side with respect to the camera module 3 by utilizing the plate spring 28 and thus, a swing operation of the camera module 3 is stabilized.

In this embodiment, the support body fixing part 28b of the plate spring 28 is fixed to the tube part 32b and the spacer member 33 in a state that the support body fixing part 28b is sandwiched between the upper end of the tube part 32b of the lower case body 32 in which the disposing hole 32c where the lower end side of the spherical member 35 is disposed is formed and the under face of the spacer member 33 and thus, the under face of the support body fixing part 28b is abutted with the upper end of the tube part 32b. Therefore, the support body fixing part 28b is fixed with the upper end of the tube part 32b as a reference in the upper and lower direction and thus, the relative positional accuracy in the upper and lower direction between the support body fixing part 28b and the supporting point part 36 is easily secured. Accordingly, the camera module 3 is appropriately urged toward the supporting point part 36 by utilizing the plate spring 28 and thus, a swing operation of the camera module 3 can be further stabilized.

In this embodiment, thicknesses in the front and rear direction and the right and left direction of four side faces which structure the tube part 32b are set to be relatively thin. However, thicknesses in the front and rear direction and the right and left direction of four side parts of the spacer member 33 which is formed in a frame shape are set to be relatively thick and thus, the support body fixing part 28b is fixed between the tube part 32b and the spacer member 33 in a stabilized state by utilizing the thickness of the spacer member 33.

In the second embodiment, the shake correction magnet 39 is directly fixed to the outer peripheral face of the camera module 3. Therefore, in the second embodiment, the size of the photographic optical device 1 is reduced in comparison with a conventional case that the shake correction magnets 39 are fixed to a yoke which is disposed so as to cover the outer peripheral face of the camera module 3. Especially, in this embodiment, the movable side fixing part 281a of the plate spring 281 is directly fixed to the camera module 3. Therefore, in comparison with a case that another member to which the movable side fixing part 281a is fixed is used separately, the size of the photographic optical device 1 is further reduced.

Further, in this embodiment, weight of the swinging portion is reduced in comparison with a case that a yoke is disposed so as to cover the outer peripheral face of the camera module 3. Further, in this embodiment, in a case that the size of the photographic optical device 1 is the same as that of a conventional photographic optical device, the sizes of the shake correction magnet 39 and the shake correction coil 38 can be made larger by a disposing space of the yoke and thus, a drive force of the swing drive mechanism 29 can be enhanced.

In this embodiment, the lens drive magnets 19 are fixed to the inner peripheral face of the tube part 14b of the cover member 14 which is formed of magnetic material and the shake correction magnets 39 are fixed to the outer peripheral face of the tube part 14b. Therefore, the cover member 14 functions as a back yoke. Accordingly, magnetic flux density passing through the lens drive coil 18 which is oppositely disposed to the lens drive magnet 19 is enhanced and magnetic flux density passing through the shake correction coil 38 which is oppositely disposed to the shake correction magnet 39 is enhanced. Further, interference between the magnetic flux generated from the lens drive magnet 19 and the magnetic flux generated from the shake correction magnet 39 is restrained. Accordingly, the lens is appropriately moved in the optical axis direction by the lens drive mechanism 7 and the camera module 3 is appropriately swung by the swing drive mechanism 29.

In this embodiment, the lens drive magnets 19 and the shake correction magnets 39 are fixed to the tube part 14b so that the magnetic pole of the oblique flat face 20c of the oblique flat faces 20c and 21c of the lens drive magnet 19 which are oppositely disposed to the shake correction magnet 39 through the tube part 14b is different from the magnetic pole of the inner side face 42a of the inner side faces 42a and 43a of the shake correction magnet 39 which is oppositely disposed to the lens drive magnet 19 through the tube part 14b. Therefore, effective magnetic circuits are formed and drive forces of the lens drive mechanism 7 and the swing drive mechanism 29 are enhanced. Further, an attraction force is acted between the lens drive magnet 19 and the shake correction magnet 39 through the tube part 14b and thus, fixing works of the lens drive magnet 19 and the shake correction magnet 39 to the tube part 14b are easy.

In this embodiment, the movable side fixing part 281a of the plate spring 281 is fixed to the upper face 8c of the spring fixing protruded part 8b of the filter holder 8. In a case that the movable side fixing part 281a is fixed to an under face of the spring fixing protruded part 8b, when the spring part 281c is resiliently bent, the movable side fixing part 281a may be easily separated from the under face of the spring fixing protruded part 8b. However, in this embodiment, even when the spring part 281c is resiliently bent, the movable side fixing part 281a is prevented from being separated from the spring fixing protruded part 8b.

In this embodiment, the fixed side fixing part 281b of the plate spring 281 is fixed to the support body 27 at a lower position with respect to the movable side fixing part 281a. Therefore, the camera module 3 is urged toward the supporting point part 36 disposed on the lower side of the camera module 3 by utilizing the plate spring 281 and thus a swing operation of the camera module 3 is stabilized.

In this embodiment, the spring fixing protruded part 8b is formed over the entire periphery of the filter holder 8. Further, the movable side fixing part 281a is formed in a substantially square frame shape. Therefore, the urging force of the spring part 281c is acted over the entire periphery of the camera module 3 and thus, a swing operation of the camera module 3 can be further stabilized.

In this embodiment, the fixed side fixing part 281b of the plate spring 281 is fixed to the tube part 32b and the spacer member 33 in a state that the fixed side fixing part 281b is sandwiched between the upper end of the tube part 32b of the lower case body 32 in which the disposing hole 32c where the lower end side of the spherical member 35 is disposed is formed and the under face of the spacer member 33. Further, the under face of the fixed side fixing part 281b is abutted with the upper end of the tube part 32b. Therefore, the fixed side fixing part 281b is fixed with the upper end of the tube part 32b as a reference in the upper and lower direction and thus, relative positional accuracy between the fixed side fixing part 281b and the supporting point part 36 in the upper and lower direction is easily secured. Therefore, the camera module 3 is appropriately urged toward the supporting point part 36 by utilizing the plate spring 281 and a swing operation of the camera module 3 is further stabilized.

In this embodiment, the plate spring 281 is fixed so that its inner side spring part 281d and its outer side spring part 281e are substantially parallel to the front and rear direction or the right and left direction. Therefore, the spring constant of the plate spring 281 in the front and rear direction can be made relatively small by operations of the inner side spring part 281d and the outer side spring part 281e which are substantially parallel to the right and left direction. Further, the spring constant of the plate spring 281 in the right and left direction can be made relatively small by operations of the inner side spring part 281d and the outer side spring part 281e which are substantially parallel to the front and rear direction. Therefore, the movable side fixing part 281a can be smoothly moved in the front and rear direction and the right and left direction. As a result, even when a swing angle of the camera module 3 is large, the camera module 3 can be swung smoothly.

### Other Embodiments

Although the present invention has been shown and described with reference to a specific embodiment, various changes and modifications will be apparent to those skilled in the art from the teachings herein.

In the first embodiment described above, the fixing hole 45a is formed in the side face of the magnet holder 45 and both ends of the shake correction magnet 39 in the right and left direction or the front and rear direction are held by the magnet holder 45 and both ends of the shake correction magnet 39 in the upper and lower direction are held by the magnet holder 45. However, the present invention is not limited to this embodiment. For example, both ends of the shake correction magnet 39 in the upper and lower direction may be held by two magnet holders, one of which is formed in a square frame shape and holds an upper end side of the shake correction magnet 39, and the other of which is formed in a square frame shape and holds a lower end side of the shake correction magnet 39. In this case, the magnet holder which holds the lower end side of the shake correction magnet 39 is fixed to the magnet holding part 28a.

In the embodiment described above, the magnet holder 45 is fixed to the magnet holding part 28a of the plate spring 28. In other words, the shake correction magnet 39 is fixed to the magnet holding part 28a through the magnet holder 45. However, the present invention is not limited to this embodiment. For example, the shake correction magnet 39 may be directly fixed to the magnet holding part 28a. In this case, the upper end side of the shake correction magnet 39 may be held or not held by a magnet holder formed in a square frame shape.

In the embodiment described above, the shake correction magnet 39 is fixed to the magnet holding part 28a through the magnet holder 45. Therefore, a distance between the swing drive mechanism 29 and the supporting point part 36 can be set larger in the upper and lower direction and a distance between the plate spring 28 and the supporting point part 36 can be set smaller. In the embodiment described above, a distance between the swing drive mechanism 29 and the supporting point part 36 can be set larger and thus, even when a swing angle of the camera module 3 is set to be small, the swing amount of the camera module 3 can be secured. Further, in the embodiment described above, the distance between the plate spring 28 and the supporting point part 36 can be set smaller and thus, even when elastic deformation amounts of the spring part 28c in the front and rear direction and the right and left direction are set to be small, the camera module 3 can be swung appropriately.

In the embodiment described above, the shake correction magnet 39 is fixed to each of four side faces of the magnet holder 45. However, the present invention is not limited to this embodiment. For example, the shake correction magnet 39 may be fixed to two side faces, which are one of the side faces in the front and rear direction and one of the side faces in the right and left direction of the magnet holder 45. In accordance with an embodiment of the present invention, the shake correction magnet 39 may be fixed to each of three side faces of four side faces of the magnet holder 45.

In the embodiment described above, the shake correction magnet 39 is directly fixed to the tube part 14b of the cover member 14 which structures the camera module 3. However, the present invention is not limited to this embodiment. For example, another tube-shaped member is fixed to an outer peripheral side of the tube part 14b and the shake correction magnet 39 may be fixed to the outer peripheral face of the another tube-shaped member.

In the embodiment described above, the shake correction device 4 is provided with the spherical member 35 as a support-point protruded part which structures the supporting point part 36. However, the present invention is not limited to this embodiment. For example, a support-point protruded part which structures the supporting point part 36 may be formed on or fixed to the under face of the camera module 3, or a support-point protruded part which structures the supporting point part 36 may be formed on or fixed to the bottom part 32a of the lower case body 32. In a case that a support-point protruded part which structures the supporting point part 36 is formed on or fixed to the under face of the camera module 3, an abutting part with which the support-point protruded part is abutted is formed on the bottom part 32a of the lower case 32.

In the embodiment described above, the lens drive mechanism 7 is a so-called voice coil motor which includes the lens drive coils 18 and the lens drive magnets 19. However, the present invention is not limited to this embodiment. For example, the lens drive mechanism 7 may be provided with a piezo-electric element or a shape-memory alloy for moving a lens in the optical axis direction instead of using the lens drive coil 18 and the lens drive magnet 19.

In the embodiment described above, the photographic optical device 1 is provided with an autofocus function but the photographic optical device 1 may be provided with no autofocus function. In other words, the camera module 3 may be provided with no lens drive mechanism 7. In this case, for example, the sleeve 13 is fixed to the holding body 6.

In the embodiment described above, the photographic optical device 1 is formed in a substantially square shape when viewed in the optical axis direction. However, the photographic optical device 1 may be formed in a substantially rectangular shape when viewed in the optical axis direction. Further, the photographic optical device 1 may be formed in another polygonal shape when viewed in the optical axis direction or in a circular shape or an elliptic shape when viewed in the optical axis direction. Similarly, the camera module 3 may be formed in a substantially rectangular shape when viewed in the optical axis direction. Further, the camera module 3 may be formed in another polygonal shape when viewed in the optical axis direction or in a circular shape or an elliptic shape when viewed in the optical axis direction.

In the embodiment described above, the camera module 3 having a lens and an imaging element is incorporated into the shake correction device 4 but a lens drive module having no lens and/or no imaging element may be incorporated into the shake correction device 4. In other words, a lens drive module which is structured of the camera module 3 provided with no lens holder 12 and/or no circuit board 22 (in other words, the lens drive module which is not provided with a photographing function but provided with a function for moving a lens in the optical axis direction) may be incorporated to the shake correction device 4. Also in this case, similar effects as the above-mentioned embodiment can be obtained. Further, in the embodiment described above, the photographic optical device 1 having the camera module 3 and the shake correction device 4 is described as an embodiment of the present invention. However, the structure of at least an embodiment of the present invention may be applied to a lens drive device having a lens drive module and the shake correction device 4. In accordance with an embodiment of the present invention, no camera module 3 and no lens drive module may be incorporated into the shake correction device 4.

In the second embodiment described above, the movable side fixing part 281a of the plate spring 281 is fixed to the upper face 8c of the spring fixing protruded part 8b. However, the present invention is not limited to this embodiment. For example, the movable side fixing part 281a may be fixed to the under face of the spring fixing protruded part 8b. Further, the movable side fixing part 281a may be directly fixed to the under face of the shake correction magnet 39 or may be fixed through an attaching member. Further, in the embodiment described above, the movable side fixing part 281a is formed in a ring shape but the movable side fixing part 281a may be formed in no ring shape. For example, the movable side fixing part 281a may be divided into four portions which are respectively connected with four spring parts 281c. Further, in the embodiment described above, the spring fixing protruded part 8b is formed over the entire periphery of the filter holder 8. However, the spring fixing protruded part 8b may be formed in a part of the outer peripheral face of the filter holder 8.

In the embodiment described above, the cover member 14 is formed of magnetic material. However, the present invention is not limited to this embodiment. For example, the cover member 14 may be formed of nonmagnetic material. Further, it may be structured that a part of the cover member 14 is formed of magnetic material and the other part of the cover member 14 is formed of nonmagnetic material.

In the embodiment described above, the lens drive magnet 19 which is formed in a substantially quadrangular prism shape is fixed to the inner sides of four corners of the tube part 14b of the cover member 14. However, the present invention is not limited to this embodiment. For example, the lens drive magnet 19 which is formed in a substantially rectangular flat plate shape may be fixed to the inner sides of four side faces which structure the tube part 14b. Further, in the embodiment described above, the lens drive coil 18 is wound around the outer peripheral face of the sleeve 13. However, the lens drive coil 18 may be an air-core coil which is wound around in a substantially rectangular shape. In this case, for example, four lens drive coils 18 in an air-core coil shape are fixed to an outer peripheral face of the sleeve 13.

In the embodiment described above, four magnet pieces 42 are magnetized so that the magnetic poles formed on the outer side faces 42b are the same as each other and four magnet pieces 43 are magnetized so that the magnetic poles formed on the outer side faces 43b are the same as each other. However, the present invention is not limited to this embodiment. For example, the magnet pieces 42 and 43 may be magnetized so that the magnetic poles formed on the outer side faces 42b of the magnet pieces 42 which are adjacent to each other in the circumferential direction are different from each other and that the magnetic poles formed on the outer side faces 43b of the magnet pieces 43 which are adjacent to each other in the circumferential direction are different from each other. In other words, the magnet pieces 42 and 43 may be magnetized so that the magnetic poles on the outer side faces 42b of the magnet pieces 42 which are fixed to the outer side faces in the right and left direction of the tube part 14b are different from the magnetic poles on the outer side faces 42b of the magnet pieces 42 which are fixed to the outer side faces in the front and rear direction of the tube part 14b, and that the magnetic poles on the outer side faces 43b of the magnet pieces 43 which are fixed to the outer side faces in the right and left direction of the tube part 14b are different from the magnetic poles on the outer side faces 43b of the magnet pieces 43 which are fixed to the outer side faces in the front and rear direction of the tube part 14b. In this case, a magnetic circuit having a high degree of efficiency can be formed and a drive force of the swing drive mechanism 29 can be enhanced.

In the embodiment described above, the shake correction magnet 39 is fixed to each of four outer side faces which structure the outer peripheral face of the tube part 14b of the cover member 14. However, the present invention is not limited to this embodiment. For example, the shake correction magnet 39 may be fixed to the two side faces, which are one of the side faces in the front and rear direction and one of the side faces in the right and left direction of the tube part 14b. In accordance with an embodiment of the present invention, the shake correction magnet 39 may be fixed to each of three outer side faces of four outer side faces which structure the outer peripheral face of the tube part 14b.

In the embodiment described above, the lens drive magnet 19 is structured of two magnet pieces, i.e., the magnet pieces 20 and 21, but the lens drive magnet 19 may be structured of one magnet piece. Similarly, the shake correction magnet 39 may be structured of one magnet piece.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A shake correction device structured to correct a shake for an optical image, the shake corrective device comprising:
a support body structured to swingably support a camera module having a lens and an imaging element; and
a shake correction mechanism structured to correct the shake by swinging the camera module so as to incline an optical axis of the lens with respect to the support body;
wherein the support body comprises a case body formed in a substantially tube shape;
wherein the shake correction mechanism comprises:
a shake correction coil which is fixed to an inner peripheral face of the case body;
a shake correction magnet which is disposed on an inner peripheral side of the case body with respect to the shake correction coil so as to face the shake correction coil; and
a spring member having a support body fixing part which is fixed to the support body, a magnet holding part which holds the shake correction magnet, and a spring part which connects the support body fixing part with the magnet holding part; and
wherein an accommodating space which is capable of accommodating the camera module is formed on an inner peripheral side of the case body with respect to the shake correction magnet.

2. The shake correction device according to claim 1, wherein
the shake correction mechanism comprises a plurality of the shake correction magnets and a magnet holder which holds the plurality of the shake correction magnets, and
the magnet holder is fixed to the magnet holding part of the spring member.

3. The shake correction device according to claim 2, wherein the magnet holder holds at least both end sides of the plurality of the shake correction magnets in an optical axis direction of the lens.

4. The shake correction device according to claim 2, further comprising a positioning part which is formed in the magnet holder for positioning the magnet holding part of the spring member in a direction which is substantially perpendicular to an optical axis direction of the lens.

5. The shake correction device according to claim 2, further comprising a supporting point part which is provided in the shake correction mechanism as a swing center for the camera module.

6. A shake correction device structured to correct a shake for an optical image, the shake correction device comprising:
a support body structured to swingably support a lens drive module,
the lens drive module comprising:
a movable body to which a lens is capable of being attached and
which is movable in an optical axis direction of the lens;
a holding body which movably holds the movable body in the optical axis direction; and
a lens drive mechanism structured to drive the movable body in the optical axis direction; and
a shake correction mechanism structured to correct the shake by swinging the lens drive module so as to incline an optical axis of the lens with respect to the support body;
wherein the support body comprises a case body which is formed in a substantially tube shape;
wherein the shake correction mechanism comprises:
a shake correction coil which is fixed to an inner peripheral face of the case body;
a shake correction magnet which is disposed on an inner peripheral side of the case body with respect to the shake correction coil so as to face the shake correction coil; and
a spring member comprising a support body fixing part which is fixed to the support body, a magnet holding part which holds the shake correction magnet, and a spring part which connects the support body fixing part with the magnet holding part; and
wherein an accommodating space which is capable of accommodating the lens drive module is formed on an inner peripheral side of the case body with respect to the shake correction magnet.

7. The shake correction device according to claim 6, wherein
the shake correction mechanism comprises a plurality of the shake correction magnets and a magnet holder which holds the plurality of the shake correction magnets, and
the magnet holder is fixed to the magnet holding part of the spring member.

8. The shake correction device according to claim 7, wherein the magnet holder holds at least both end sides of the plurality of the shake correction magnets in the optical axis direction.

9. The shake correction device according to claim 7, further comprising a positioning part which is formed in the magnet holder for positioning the magnet holding part of the spring member in a direction which is substantially perpendicular to the optical axis direction.

10. The shake correction device according to claim 7, further comprising a supporting point part which is provided in the shake correction mechanism as a swing center for the lens drive module.

11. A photographic optical device comprising:
a shake correction device structured to correct a shake for an optical image comprising:
a support body structured to swingably support a camera module having a lens and an imaging element; and
a shake correction mechanism structured to correct the shake by swinging the camera module so as to incline an optical axis of the lens with respect to the support body;
wherein the support body comprises a case body formed in a substantially tube shape;
wherein the shake correction mechanism comprises:
a shake correction coil which is fixed to an inner peripheral face of the case body;
a shake correction magnet which is disposed on an inner peripheral side of the case body with respect to the shake correction coil so as to face the shake correction coil; and
a spring member having a support body fixing part which is fixed to the support body, a magnet holding part which holds the shake correction magnet, and a spring part which connects the support body fixing part with the magnet holding part; and
wherein an accommodating space which is capable of accommodating the camera module is formed on an inner peripheral side of the case body with respect to the shake correction magnet; and
the camera module which is accommodated in the accommodating space,
wherein the shake correction magnet is fixed to the camera module.

12. The photographic optical device according to claim 11, wherein
the shake correction mechanism comprises a supporting point part as a swing center for the camera module, and
when a side where an object to be photographed is located is an object side and a side where the imaging element is disposed is an opposite-to-object side in an optical axis direction of the lens, the supporting point part is disposed on the opposite-to-object side with respect to the camera module, and the support body fixing part is disposed on the opposite-to-object side with respect to the magnet holding part.

13. The photographic optical device according to claim 12, wherein
the support body comprises:
an opposite-to-object side case body which is formed with an abutting part with which a support-point protruded part structuring the supporting point part is abutted, or where the support-point protruded part is formed or fixed; and
a fixing member structured to fix the support body fixing part; and
the support body fixing part is fixed in a sandwiched state between the fixing member and the opposite-to-object side case body in the optical axis direction.

14. A lens drive device comprising:
a shake correction device structured to correct a shake for an optical image comprising:
a support body structured to swingably support a lens drive module, the lens drive module comprising:
a movable body to which a lens is capable of being attached and which is movable in an optical axis direction of the lens;
a holding body which movably holds the movable body in the optical axis direction; and
a lens drive mechanism structured to drive the movable body in the optical axis direction; and
a shake correction mechanism structured to correct the shake by swinging the lens drive module so as to incline an optical axis of the lens with respect to the support body;
wherein the support body comprises a case body which is formed in a substantially tube shape;
wherein the shake correction mechanism comprises:
a shake correction coil which is fixed to an inner peripheral face of the case body;
a shake correction magnet which is disposed on an inner peripheral side of the case body with respect to the shake correction coil so as to face the shake correction coil; and
a spring member comprising a support body fixing part which is fixed to the support body, a magnet holding part which holds the shake correction magnet, and a spring part which connects the support body fixing part with the magnet holding part; and
wherein an accommodating space which is capable of accommodating the lens drive module is formed on an inner peripheral side of the case body with respect to the shake correction magnet; and
the lens drive module which is accommodated in the accommodating space;
wherein the shake correction magnet is fixed to the lens drive module.

15. The lens drive device according to claim 14, wherein
the shake correction mechanism comprises a supporting point part as a swing center for the lens drive module, and
when a side where an object to be photographed is located is an object side and an opposite side to an object to be photographed side is an opposite-to-object side in an optical axis direction, the supporting point part is disposed on the opposite-to-object side with respect to the lens drive module, and the support body fixing part is disposed on the opposite-to-object side with respect to the magnet holding part.

16. The lens drive device according to claim 15, wherein
the support body comprises:
an opposite-to-object side case body which is formed with an abutting part with which a support-point protruded part structuring the supporting point part is abutted, or where the support-point protruded part is formed or fixed; and
a fixing member structured to fix the support body fixing part; and
the support body fixing part is fixed in a sandwiched state between the fixing member and the opposite-to-object side case body in the optical axis direction.

17. A photographic optical device comprising:
a camera module having a lens and an imaging element; and
a shake correction device structured to correct a shake for an optical image which is formed on the imaging element through the lens;
wherein the shake correction device comprises:
a support body which swingably supports the camera module; and
a shake correction mechanism structured to swing the camera module so as to incline an optical axis of the lens with respect to the support body to correct the shake; and
wherein the shake correction mechanism comprises:
a shake correction magnet which is directly fixed to an outer peripheral face of the camera module; and
a shake correction coil which is fixed to the support body and is oppositely disposed to the shake correction magnet.

18. The photographic optical device according to claim 17, wherein
the camera module comprises:
a movable body which holds the lens and is movable in an optical axis direction of the lens;
a holding body which movably holds the movable body in the optical axis direction; and
a lens drive mechanism structured to drive the movable body in the optical axis direction,
the lens drive mechanism comprises a lens drive coil which is fixed to an outer peripheral face of the movable body and a lens drive magnet which is fixed to the holding body and is oppositely disposed to the lens drive coil,
the holding body is provided with a cover member in a substantially tube shape which is formed of magnetic material and structures an outer peripheral face of the camera module, and
the lens drive magnet is fixed to an inner peripheral face of the cover member and the shake correction magnet is fixed to an outer peripheral face of the cover member.

19. The photographic optical device according to claim 18, wherein
a first opposing face which is an opposing face of the lens drive magnet that faces the shake correction magnet through the cover member and a second opposing face which is an opposing face of the shake correction magnet that faces the first opposing face through the cover member are magnetized so that two different magnetic poles are superposed on each other in the optical axis direction, and
when a side on which an object to be photographed is located is an object side in the optical axis direction, the lens drive magnet and the shake correction magnet are fixed to the cover member so that the magnetic pole disposed on the object side of the first opposing face is different from the magnetic pole disposed on the object side of the second opposing face.

20. The photographic optical device according to claim 17, wherein
the shake correction mechanism comprises a spring member which connects the camera module and the support body, and
the spring member comprises a movable side fixing part which is directly fixed to the camera module, a fixed side fixing part which is fixed to the support body, and a spring part which connect the movable side fixing part with the fixed side fixing part and is structured to enable to perform a swing operation of the camera module.

21. The photographic optical device according to claim 20, wherein
the shake correction mechanism comprises a supporting point part as a swing center for the camera module, and
when a side where an object to be photographed is located is an object side and a side where the imaging element is disposed is an opposite-to-object side in an optical axis direction of the lens, the supporting point part is disposed on the opposite-to-object side with respect to the camera module, and the fixed side fixing part is disposed on the opposite-to-object side with respect to the movable side fixing part.

22. The photographic optical device according to claim 21, wherein
the camera module is formed with a spring fixing protruded part to which the movable side fixing part is fixed so as to protrude in a direction substantially perpendicular to the optical axis direction, and
the movable side fixing part is fixed to a face on the object side of the spring fixing protruded part.

23. The photographic optical device according to claim 22, wherein
the spring fixing protruded part is formed over an entire periphery of the camera module, and
the movable side fixing part is formed in a ring shape.

24. The photographic optical device according to claim 21, wherein
the support body comprises:
an opposite-to-object side case body which is formed with an abutting part with which a support-point protruded part structuring the supporting point part is abutted, or where the support-point protruded part is formed or fixed; and
a fixing member structured to fix the fixed side fixing part; and
the fixed side fixing part is fixed in a sandwiched state between the fixing member and the opposite-to-object side case body in the optical axis direction.

25. The photographic optical device according to claim 20, wherein
the shake correction mechanism comprises a plurality of the shake correction magnets and a plurality of the shake correction coils for swinging the camera module with a first direction and a second direction which are substantially perpendicular to the optical axis direction and are substantially perpendicular to each other as axial directions for swinging, and
the spring part is provided with a first spring part which is substantially parallel to the first direction and a second spring part which is substantially parallel to the second direction.

26. A lens drive device comprising:
a lens drive module comprising:
a movable body which is capable of attaching a lens and is movable in an optical axis direction of the lens;
a holding body which movably holds the movable body in the optical axis direction; and
a lens drive mechanism structured to drive the movable body in the optical axis direction; and
a shake correction device structured to correct a shake for an optical image which is formed through the lens;
wherein the shake correction device comprises:
a support body which swingably supports the lens drive module; and
a shake correction mechanism structured to swing the lens drive module so as to incline an optical axis of the lens with respect to the support body to correct the shake; and
wherein the shake correction mechanism comprises:
a shake correction magnet which is directly fixed to an outer peripheral face of the lens drive module; and
a shake correction coil which is fixed to the support body and is oppositely disposed to the shake correction magnet.

27. The lens drive device according to claim 26, wherein
the lens drive mechanism comprises a lens drive coil which is fixed to an outer peripheral face of the movable body and a lens drive magnet which is fixed to the holding body and is oppositely disposed to the lens drive coil,
the holding body is provided with a cover member in a substantially tube shape which is formed of magnetic material and structures an outer peripheral face of the lens drive module, and
the lens drive magnet is fixed to an inner peripheral face of the cover member and the shake correction magnet is fixed to an outer peripheral face of the cover member.

28. The lens drive device according to claim 27, wherein
a first opposing face which is an opposing face of the lens drive magnet that faces the shake correction magnet through the cover member and a second opposing face which is an opposing face of the shake correction magnet that faces the first opposing face through the cover member are magnetized so that two different magnetic poles are superposed on each other in the optical axis direction, and
when a side on which an object to be photographed is located is an object side in the optical axis direction, the lens drive magnet and the shake correction magnet are fixed to the cover member so that the magnetic pole disposed on the object side of the first opposing face is different from the magnetic pole disposed on the object side of the second opposing face.

29. The lens drive device according to claim 26, wherein
the shake correction mechanism comprises a spring member which connects the lens drive module and the support body, and
the spring member comprises a movable side fixing part which is directly fixed to the lens drive module, a fixed side fixing part which is fixed to the support body, and a spring part which connect the movable side fixing part with the fixed side fixing part and is structured to enable to perform a swing operation of the lens drive module.

30. The lens drive device according to claim 29, wherein
the shake correction mechanism comprises a supporting point part as a swing center for the lens drive module, and
when a side where an object to be photographed is located is an object side and an opposite side to an object to be photographed side is an opposite-to-object side in the optical axis direction, the supporting point part is disposed on the opposite-to-object side with respect to the lens drive module and the fixed side fixing part is disposed on the opposite-to-object side with respect to the movable side fixing part.

31. The lens drive device according to claim 30, wherein
the lens drive module is formed with a spring fixing protruded part to which the movable side fixing part is fixed so as to protrude in a direction substantially perpendicular to the optical axis direction, and
the movable side fixing part is fixed to a face on the object side of the spring fixing protruded part.

32. The lens drive device according to claim 31, wherein
the spring fixing protruded part is formed over an entire periphery of the lens drive module, and
the movable side fixing part is formed in a ring shape.

33. The lens drive device according to claim 30, wherein
the support body comprises:
an opposite-to-object side case body which is formed with an abutting part with which a support-point protruded part structuring the supporting point part is abutted, or where the support-point protruded part is formed or fixed; and
a fixing member structured to fix the fixed side fixing part; and
the fixed side fixing part is fixed in a sandwiched state between the fixing member and the opposite-to-object side case body in the optical axis direction.

34. The lens drive device according to claim 29, wherein
the shake correction mechanism comprises a plurality of the shake correction magnets and a plurality of the shake correction coils for swinging the lens drive module with a first direction and a second direction which are substantially perpendicular to the optical axis direction and are substantially perpendicular to each other as axial directions for swinging, and
the spring part is provided with a first spring part which is substantially parallel to the first direction and a second spring part which is substantially parallel to the second direction.

35. The shake correction device according to claim 2, wherein
the case body is formed in a substantially rectangular tube shape,
the magnet holder which is disposed on an inner side of the case body formed in a substantially rectangular tube shape is also formed in a substantially rectangular tube shape,
each of four side faces of the magnet holder is formed with a fixing hole in a substantially rectangular shape so as to penetrate through the side face for fixing the shake correction magnet, and
an inner side face of the shake correction magnet is capable of being fixed to an outer side face of the camera module.

36. The shake correction device according to claim 35, wherein
the magnet holding part and the support body fixing part of the spring member are formed in a substantially rectangular frame shape,
a lower end face of the magnet holder is fixed to an upper face of the magnet holding part, and
the shake correction magnet is attached to the support body through the magnet holder and the spring member in a state that the shake correction magnet is not fixed to the outer side face of the camera module.

37. The shake correction device according to claim 36, wherein each of the lower end faces of the four side faces of the magnet holder is formed with a positioning part for positioning the magnet holding part which structures the spring member.

38. The shake correction device according to claim 7, wherein
the case body is formed in a substantially rectangular tube shape,
the magnet holder which is disposed on an inner side of the case body formed in a substantially rectangular tube shape is also formed in a substantially rectangular tube shape,
each of four side faces of the magnet holder is formed with a fixing hole in a substantially rectangular shape so as to penetrate through the side face for fixing the shake correction magnet, and
an inner side face of the shake correction magnet is capable of being fixed to an outer side face of the lens drive module.

39. The shake correction device according to claim 38, wherein
the magnet holding part and the support body fixing part of the spring member are formed in a substantially rectangular frame shape,
a lower end face of the magnet holder is fixed to an upper face of the magnet holding part, and
the shake correction magnet is attached to the support body through the magnet holder and the spring member in a state that the shake correction magnet is not fixed to the outer side face of the lens drive module.

40. The shake correction device according to claim 39, wherein each of the lower end faces of the four side faces of the magnet holder is formed with a positioning part for positioning the magnet holding part which structures the spring member.

41. The photographic optical device according to claim 19, wherein
the cover member in a substantially tube shape which structures an outer peripheral face of the camera module is formed in a substantially rectangular tube shape,
the lens drive magnet is fixed to each of inner sides of four corners of a tube part of the cover member in a substantially rectangular tube shape so as to face an outer peripheral face of the lens drive coil through a predetermined gap space,
the shake correction magnet is formed in a substantially rectangular flat plate shape, and
each of the four shake correction magnets is fixed to each of four outer side faces of the tube part of the cover member in a substantially rectangular tube shape.

42. The lens drive device according to claim 28, wherein
the cover member in a substantially tube shape which structures an outer peripheral face of the lens drive module is formed in a substantially rectangular tube shape,
the lens drive magnet is fixed to each of inner sides of four corners of a tube part of the cover member in a substantially rectangular tube shape so as to face an outer peripheral face of the lens drive coil through a predetermined gap space,
the shake correction magnet is formed in a substantially rectangular flat plate shape, and
each of the four shake correction magnets is fixed to each of four outer side faces of the tube part of the cover member in a substantially rectangular tube shape.
